(19) United States
(12) Patent Application Publication
(10) Pub. No.: US 2017/0070911 A1
(43) Pub. Date: Mar. 9, 2017

(54) Adaptive mid-packet detection in wireless communications

(71) Applicant: Intel IP Corporation, Santa Clara, CA (US)

(72) Inventors: Po-Kai Huang, Santa Clara, CA (US); Xiaogang Chen, Beijing (CN); Qinghua Li, San Ramon, CA (US); Robert Stacey, Portland, OR (US)

(21) Appl. No.: 14/757,827

(22) Filed: Dec. 26, 2015

Related U.S. Application Data
(60) Provisional application No. 62/214,712, filed on Sep. 4, 2015.

(51) Int. Cl. H04W 28/06; H04L 5/00; H04W 72/08; H04W 72/04

(52) U.S. Cl. CPC H04W 28/06; H04W 72/0446; H04L 5/0007; H04W 72/085; H04W 84/12

(57) ABSTRACT

Adaptive sensing times for mid-packet detection in wireless transmissions are provided. In some embodiments, the adaptive sensing times are selected according to criteria based, at least in part, on a defined condition associated with strength of wireless signals and/or a satisfactory performance in the determination of presence or absence of wireless signal in a communication channel.

### CROSS-REFERENCE TO RELATED APPLICATION

This application claims priority from U.S. Provisional Patent Application No. 62/214,712, filed Sep. 4, 2015, the entirety of which application is hereby incorporated herein by reference.

### BACKGROUND

In some wireless environments, communication devices (e.g., access point devices, station devices, or the like) can transmit or can attempt to transmit information within a limited amount of radiofrequency (RF) spectrum that is shared among the communication devices. As such, some wireless communication protocols (such as the family of Wi-Fi protocols) can include periods of contention and/or backoff prior to transmission of information from a communication device. Such periods can be utilized or otherwise relied upon to determine whether a channel, for example, is clear for the transmission.

### BRIEF DESCRIPTION OF THE DRAWINGS

The accompanying drawings form an integral part of the disclosure and are incorporated into the present specification. The drawings illustrate example embodiments of the disclosure and, in conjunction with the description and claims, serve to explain at least in part various principles, features, or aspects of the disclosure. Some embodiments of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 illustrates an example of an operational environment for wireless communication in accordance with one or more embodiments of the disclosure.

FIG. 2 illustrates an example of receiver apparatus within a communication device for adaptive mid-packet detection (MPD) in accordance with one or more embodiments of the disclosure.

FIG. 3A illustrates an example of MPD sensing for primary channel in accordance with one or more embodiments of the disclosure.

FIG. 3B presents an example of an apparatus for adaptive MPD sensing in accordance with one or more embodiments of the disclosure.

FIG. 4 illustrates examples of simulated mid-packet detection performance in accordance with one or more embodiments of the disclosure.

FIGS. 5-6 illustrated examples of throughput performance in a network environment including devices configured to perform fixed-sensing-time MPD and adaptive MPD in accordance with one or more embodiments of the disclosure.

FIG. 7 illustrates an example of MPD sensing for a secondary channel in accordance with one or more embodiments of this disclosure.

FIG. 8 presents an example of a device for wireless communication in accordance with one or more embodiments of the disclosure.

FIG. 9 presents an example of a radio unit for wireless communication in accordance with one or more embodiments of the disclosure.

FIG. 10 presents an example of a computational environment for wireless communication in accordance with one or more embodiments of the disclosure.

FIG. 11 presents another example of a communication device for wireless communication in accordance with one or more embodiments of the disclosure.

FIG. 12 presents an example method for adaptive MPD in accordance with one or more embodiments of the disclosure.

### DETAILED DESCRIPTION

The disclosure recognizes and addresses, in at least some aspects, the issue of wireless transmissions (or other type of communications) in which a clear channel assessment, which also may be referred to as mid-packet detection (MPD), is to be performed in order to determine whether a packet is present in a channel and, thus, whether wireless transmission can be implemented. It is noted that after presence of a packet is ascertained, via mid-packet detection, the power of the packet can be evaluated as part of the assessment of whether the wireless transmission can proceed. Embodiments of this disclosure permits a communication device (e.g., a station device (STA) or an AP device) to determine, prior to contending, a value of sensing time and/or a comparison threshold γ for determining whether packet(s) is present in a channel. The so determined sensing time can be based at least on interframe spacings (e.g., short interframe space (SIFS) and/or arbitration interframe space (AIFS)) and a number of backoff windows. Therefore, in some embodiments, sensing time for MPD can be changed adaptively based at least on the interval available for sensing. Accordingly, various improvements over MPD with fixed sensing time can be attained via the embodiments of this disclosure. In one example, better performance can be obtained by using longer sensing time when the available interval for sensing is long. In another example, satisfactory or otherwise reasonable performance can be obtained by using a short (or, in some embodiments, shorter) sensing time when the available interval for sensing is short. In one example, satisfactory performance can correspond to performance that satisfied a defined performance criterion (e.g., a defined value or miss rate).

More specifically, yet not exclusively, the disclosure provides devices, systems, techniques, and/or computer program products for mid-packet detection (MPD) that utilizes or otherwise leverages adaptive sensing periods (or sensing times) based on intervals available prior to a wireless communication. In some example implementations, the MPD in accordance with this disclosure can utilize a correlation mechanism that can include defined periods (e.g., a specific number of symbols) for the determination of moving averages and defined thresholds that can permit determining whether a channel is available (e.g., clear) for communication. In accordance with this disclosure, such defined periods can be adaptive or otherwise selectable based at least on an expected interval available prior to a transmission. While various embodiments of the disclosure are illustrated in connection with communication within a 20 MHz channel, it should be appreciated that the disclosure is not limited in that respect and other channel bandwidths (40 MHz, 80 MHz, 160 MHz or 80+80 MHz) are contemplated. Further, the elements described herein in connection with MPD adaptive sensing can be implemented in wireless communications according to any radio technology protocol in which contention and/or backoff is implemented, not just Wi-Fi protocols, such as those of the Institute of Electrical and Electronics Engineers (IEEE) 802.11 family of standards.

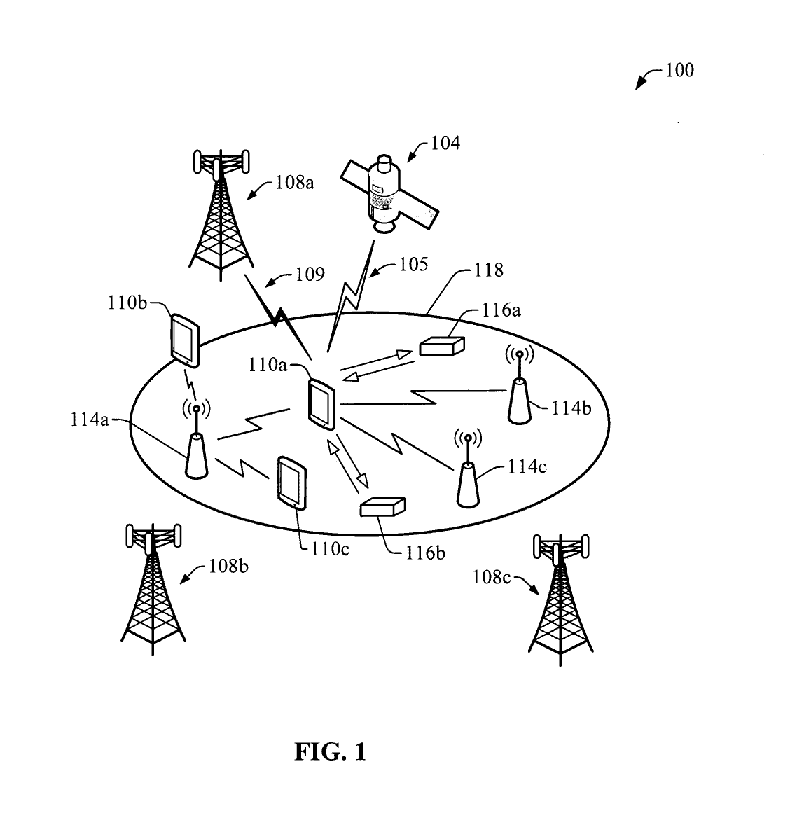

With reference to the drawings, FIG. 1 presents a block diagram of an example operational environment 100 for wireless communication in accordance with at least some aspects of the disclosure. The operational environment 100 includes several telecommunication infrastructures and communication devices, which collectively can embody or otherwise constitute a telecommunication environment. More specifically, yet not exclusively, the telecommunication infrastructures can include a satellite system 104. As described herein, the satellite system 104 can be embodied in or can include a global navigation satellite system (GNSS), such as the Global Positioning System (GPS), Galileo, GLONASS (Globalnaya navigatsionnaya sputnikovaya sistema), BeiDou Navigation Satellite System (BDS), and/or the Quasi-Zenith Satellite System (QZSS). In addition, the telecommunication infrastructures can include a macro-cellular or large-cell system; which is represented with three base stations 108a-108c; a micro-cellular or small-cell system, which is represented with three access point devices 114a-114c; and a sensor-based system—which can include proximity sensor(s), beacon device(s), pseudo-stationary device(s), and/or wearable device(s)—represented with functional elements 116a-116c. In some embodiments, one or more of the access point (AP) devices can be embodied in or can include respective low-power base station device(s). As illustrated, in one implementation, each of the transmitter(s), receiver(s), and/or transceiver(s) included in respective computing devices (such as telecommunication infrastructure) can be functionally coupled (e.g., communicatively or otherwise operationally coupled) with the wireless device 110a (also referred to as communication device 110a) via wireless link(s) in accordance with specific radio technology protocols (e.g., IEEE 802.11a, IEEE 802.11ac, IEEE 802.11ax, etc.) in accordance with aspects of this disclosure. For another example, a base station (e.g., base station 108a) can be functionally coupled to the wireless devices 110a, 110b, and 110c via respective an upstream wireless link (UL) and a downstream link (DL) configured in accordance with a radio technology protocol for macro-cellular wireless communication (e.g., 3^{rd} Generation Partnership Project (3GPP) Universal Mobile Telecommunication System (UMTS) or “3G,” “3G”; 3GPP Long Term Evolution (LTE), or LTE); LTE Advanced (LTE-A)). For yet another example, an access point (e.g., access point 114a) can be functionally coupled to one or more of the wireless devices 110a, 110b, or 110c via a respective UL and DL configured in accordance with a radio technology protocol for small-cell wireless communication (e.g., femtocell protocols, Wi-Fi, and the like). For still another example, a beacon device (e.g., device 116a) can be functionally coupled to the wireless device 110a with a UL-only (ULO), a DL-only, or an UL and DL, each of such wireless links (represented with open-head arrows) can be configured in accordance with a radio technology protocol for point-to-point or short-range wireless communication (e.g., Zigbee, Bluetooth®, or near field communication (NFC) standards, ultrasonic communication protocols, or the like).

In the operational environment 100, the small-cell system and/or the beacon devices can be contained in a confined area 118 that can include an indoor region (e.g., a commercial facility, such as a shopping mall) and/or a spatially-confined outdoor region (such as an open or semi-open parking lot or garage). The small-cell system and/or the beacon devices can provide wireless service to a device (e.g., wireless device 110a or 110b) within the confined area 118. For instance, the wireless device 110a can handover from macro-cellular wireless service to wireless service provided by the small-cell system present within the confined area 118. Similarly, in some scenarios, the macro-cellular system can provide wireless service to a device (e.g., the wireless device 110a) within the confined area 118.

In some embodiments, the wireless device 110a, as well as other communication devices (wireless or wireline) contemplated in the present disclosure, can include electronic devices having computational resources, including processing elements (e.g., processor(s) or other processing component(s)); memory elements (one or more memory devices (collectively referred to as memory); and communication elements (e.g., a radio unit) for exchange of information within the computing device and/or with other computing devices. Such resources can have different levels of architectural complexity depending on specific device functionality. Exchange of information among computing devices in accordance with aspects of the disclosure can be performed wirelessly as described herein, and thus, in one aspect, the wireless device 110a also can be referred to as wireless communication device 110a, wireless computing device 110a, communication device 110a, or computing device 110a interchangeably. The same nomenclature considerations apply to wireless device 110b and wireless device 110c. More generally, in the present disclosure, a communication device can be referred to as a computing device or a device and, in some instances, the terminology “communication device” can be used interchangeably with the terminology “computing device” or “device,” unless context clearly dictates that a distinction should be made. In addition, a communication device (e.g., communication device 110a or 110b or 110c) that operates according to HEW can utilize or leverage a physical layer convergence protocol (PLCP) and related PLCP protocol data units (PPDUs) in order to transmit and/or receive wireless communications. Example of the computing devices that can communicate wirelessly in accordance with aspects of the present disclosure can include desktop computers with wireless communication resources; mobile computers, such as tablet computers, smartphones, notebook computers, laptop computers with wireless communication resources, Ultrabook™ computers; gaming consoles, mobile telephones; blade computers; programmable logic controllers; near field communication devices; customer premises equipment with wireless communication resources, such as set-top boxes, wireless routers, wireless-enabled television sets, or the like; and so forth. The wireless communication resources can include radio units (also referred to as radios) having circuitry for processing of wireless signals, processor(s), memory device(s), and the like, where the radio, the processor(s), and the memory device(s) can be coupled via a bus architecture.

The computing devices included in the example operational environment 100, as well as other computing devices contemplated in the present disclosure, can implement adaptive MPD based on an adaptively selected sensing time based at least on available time prior to a wireless transmission, as described herein. It should be appreciated that other functional elements (e.g., servers, routers, gateways, and the like) can be included in the operational environment 100. It should be appreciated that the adaptive mid-packet detection elements of this disclosure can be implemented in any telecommunication environment including a wireline network (e.g., a cable network, an internet-protocol (IP) network, an industrial control network, any wide area network (WAN), a local area network (LAN), a personal area network (PAN), a sensor-based network, or the like); a wireless network (e.g., a cellular network (either small-cell network or macro-cell network), a wireless WAN (WWAN), a wireless LAN (WLAN), a wireless PAN (WPAN), a sensor-based network, a satellite network, or the like); a combination thereof; or the like.

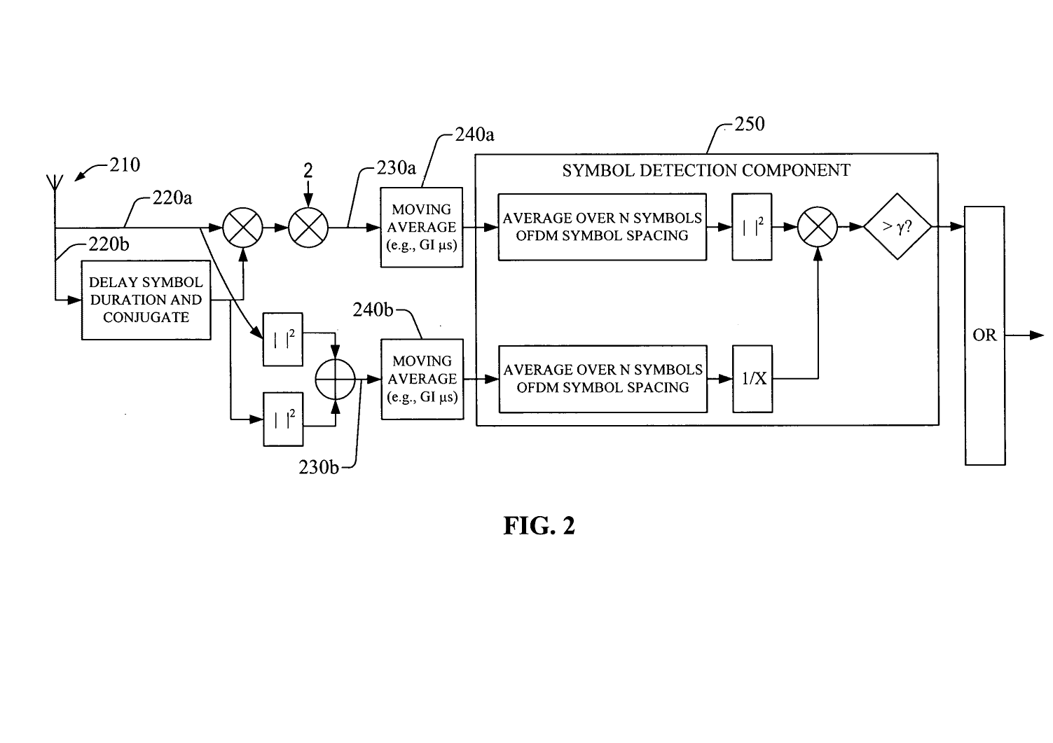

FIG. 2 illustrates an example of a receiver circuitry 200 within a communication device for adaptive MPD sensing in accordance with one or more embodiments of the disclosure. In general, as mentioned, MPD sensing also may be referred to as clear channel assessment (CCA). In some embodiments, adaptive MPD sensing can be implemented via correlation of two streams of symbols, where one of the streams is delayed and conjugated with respect to the other stream. As illustrated the receiver circuitry includes one or more antennas 210 that can receive wireless signal (e.g., pilot signal) according to a radio technology protocol. The exemplified receiver 200 can include circuitry (e.g., one or more processors or other types of component(s)) that can split a received stream of information (e.g., symbols) into two streams 220a and 220b. Such circuitry or other circuitry coupled thereto can apply a delay to the symbol duration of the stream 220b and also can apply a conjugate operation. In addition or in some embodiments, the circuitry or the other circuitry coupled thereto can determine (e.g., compute) received power for each of the streams 220a and 220b. To the end, for example, the amplitude of the signal indicative of each symbol in each of the streams 220a and 220b can be determined by such circuitry. The determined amplitudes can be combined and an output 230b can be generated by the circuitry. A moving average 240b over a defined (e.g., statically predetermined or dynamically determined) interval also can be computed or otherwise determined by such circuitry, for example. Similarly, in some embodiments, the stream 220a and the stream resulting from applying the delay and conjugate operation can be combined with another operation by the circuitry, for example, to form an output 230a. A moving average 240a over the defined interval also can be determined by the circuitry. In some embodiments, the defined interval embodies or otherwise includes a sensing period for CCA.

The exemplified receiver circuitry 200 can include a symbol detection component 250 that can determine, for example, two averages of OFDM symbols spacing over N symbols (with N a natural number greater than 1). In some aspects, the averages can be utilized to determine a metric associated with (e.g., indicative of) power and/or CCA. In some embodiments, one of the averages, as determined via input from signal 240b, can be indicative or otherwise representative of power. In other embodiments, one of the averages, as determined via input from signal 240a, can be representative of signal and the other average, as determined via input from signal 240b can be inverted in order to be utilized for normalization of the first average (e.g., the average related to the input from the signal 240a). The determined metric (e.g., a scalar number) can be compared to a defined threshold γ (a scalar number, for example). In scenarios in which a comparison between the metric and γ that indicates that the metric is greater than the defined threshold can indicate or otherwise represent an affirmative mid-packet detection—e.g., outcome of CCA conveys that a packet is present in the assessed channel. It is noted that any normalization (other than received power or a function of the received power, for example) can be utilized in the symbol detection component 250 in order to determine whether a mid-packet detection has occurred. For instance, any function of a received signal can be utilized as the normalization.

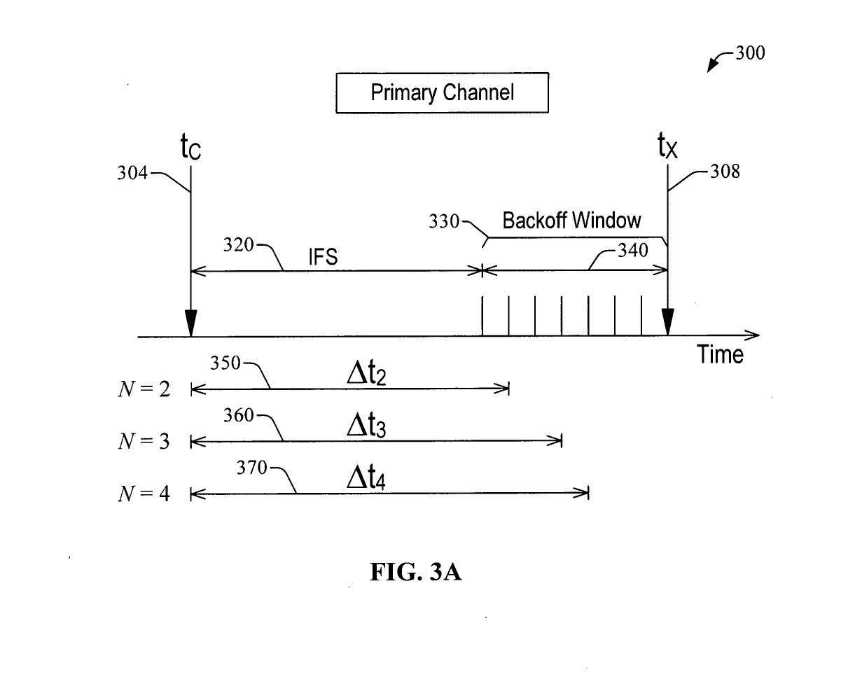

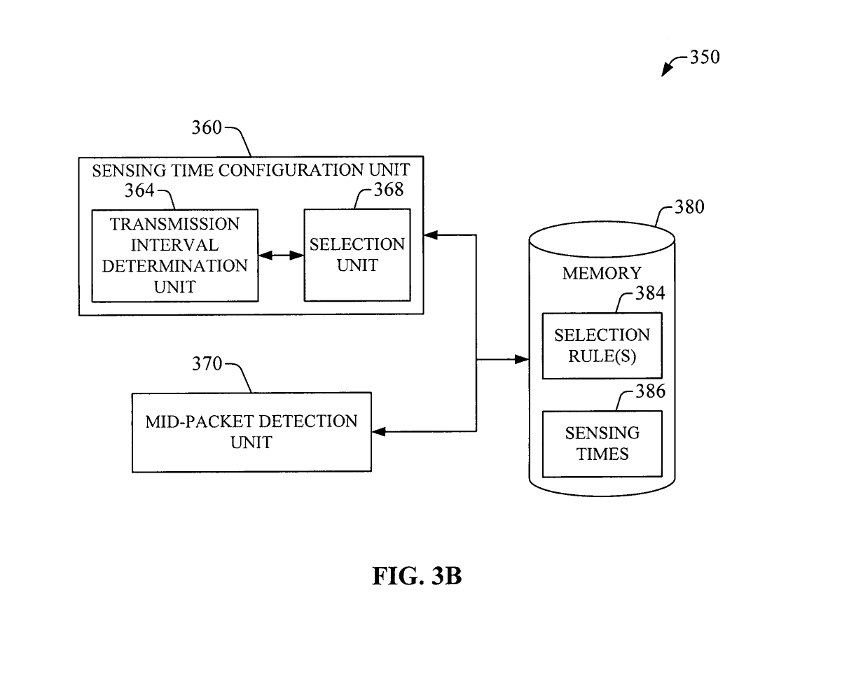

Regardless of the specific approach for MPD (or CCA), the performance of MPD can be better for longer sensing times—e.g., in scenarios in which the number of symbols N averaged for MPD is high. Yet, as N becomes higher, MPD can require higher sensing time because of the greater number of symbols utilized in the average determination. In one aspect, the sensing time may not adopt an arbitrary value, but rather the sensing time may be constrained elapse at a backoff slot boundary within the backoff window. For instance, for N equal to 2, 3, and 4, the respective backoff slot boundaries can correspond to 1 backoff slot, 3 backoff slots, and 4 backoff slots. Thus, in some embodiments, under the 4× symbol duration for PPDU in IEEE 802.1 lax and IFS equals to about 34 μs, the sensing time can be about 43 μs, about 61 μs, and about 70 μs, when N is equal to 2, 3, and 4 symbols, respectively. Therefore, in such embodiments, setting or otherwise selecting N=4 can provide best performance. Yet, when MPD is applied to the primary channel, a communication device (e.g., a STA device or an AP device) may not have access to 70 μs for MPD sensing. Further, setting or otherwise selecting N=2 can ensure that MPD sensing can be applied in most scenarios, at least on the primary channel, but performance of MPD may not meet defined (e.g., satisfactory or otherwise stringent) detection requirements. As an illustration, FIG. 3A presents such MPD considerations for a primary channel having a defined spectral bandwidth (e.g., 20 MHz, 40 MHz, 60 MHz, 80 MHz, 80+80 MHz, etc.). As illustrated, contention can begin at t_{C} 304 and, in response, a device (e.g., a STA or an AP device) can determine a backoff window 330 having a defined number of backoff slots (seven backoff slots are shown in FIG. 3A, as an example). The backoff window 330 spans a backoff period 340 during which the device can backoff after an interframe spacing (IFS) interval 320. In some embodiments, the IFS interval 320 can include a SIFS interval. In addition or in other embodiments, the IFS interval can include an AIFS interval. In one example, the SIFS interval can be equal to about 16 μs, and the AIFS interval can be equal to or greater than about 34 μs. Transmission may occur at a time t_{X} 308. As shown in FIG. 3A, three sensing times Δt₂ 350, Δt₃ 360, and Δt₄ 370 corresponding to N=2, N=3, and N=4 can be selected or otherwise determined for MPD. As illustrated, in the primary channel, a sensing time spans the IFS interval 320 and a net interval spanned by the number n (a natural number) of backoff slots associated with the sensing time. Specifically, for Δt₂ 350, n=1; for Δt₃ 360, n=3; and for Δt₄ 370, n=4.

As described herein, a defined threshold γ can be relied upon, at least in part, in order to determine that a communication channel is idle or that it carries or otherwise conveys a packet. In some embodiments, a device (e.g., a STA or an AP device) can determine, prior to contending, a value of N and/or a value of the defined threshold γ based at least on an interframe spacing interval (e.g., SIFS interval and/or AIFS interval) and/or a backoff window interval. Therefore, the device or a communication device integrated therein can change adaptively a sensing time for MPD based at least on the interval available for sensing—e.g., the interval between the instant at which the communication device begins to contend and the instant at which the last backoff slot in the backoff window interval has elapsed (see, e.g., FIG. 3A).

Accordingly, as mentioned, various improvements over MPD with fixed sensing time can be attained via the embodiments of this disclosure. In one example, better performance can be obtained by using longer sensing time (e.g., N=4) when the available interval for sensing is long. In another example, satisfactory or otherwise reasonable performance can be obtained by using a short (or, in some embodiments, shorter) sensing time (e.g., N=2) when the available interval for sensing is short.

Sensing times with different performance criteria (such as a specific miss rate) can be defined or otherwise configured as described herein. A communication device (e.g., a STA device) can select or otherwise determine a sensing time for MPD in accordance with aspects described herein. More specifically, in some embodiments, defined sensing times can be included in a set S. In one example, the set S can include a defined maximum sensing time, e.g., 70 μs. In an example implementation, before a station device (or another type of device that can communicate wirelessly) starts to contend, the station device can select or otherwise determine the largest sensing time in set S that is smaller than an available interval for sensing, e.g., SIFS+σ*AIFSN[AC]+σ*T_{BW} for QoS STAB having a defined access category (AC), where AIFSN[AC] represents AIFS-number for the AC, a represents slot time, and T_{BW} represents the period spanned by a backoff window. In other implementations, the stations device can select another sensing time from the set S. The station device (or the other type of device that can communicate wirelessly) also can adjust parameters of an MPD implementation (e.g., moving average intervals, threshold γ, etc.) based at least on a selected sensing time. Therefore, the station device can perform MPD on a primary channel based at least on the selected sensing interval Δt. In addition, the station device can perform MPD based at least on the selected sensing period Δt prior to an actual transmission on secondary channel. Example of Δt can include 43 μs, 61 μs, or 70 μs.

In some embodiments, such as the embodiment shown in FIG. 3B, an apparatus for adaptive MPD can include a sensing time configuration unit 360 that can select or otherwise determine a sensing time for MPD in response to an available time prior to a wireless transmission, in accordance with a selection rule based on signal strength thresholds and/or an intended or otherwise satisfactory performance for the MPD. To that end, in some aspects, a transmission interval determination unit 364 can determine the instant (e.g., t_{C} 304) at which a communication device or another device including the communication device initiates contention for communication resources (e.g., time, tones, resource units, or the like). In addition or in other aspects, the transmission interval determination unit 364 can determine an IFS interval (e.g., IFS 320) and/or a backoff interval (e.g., backoff period 340). Such determinations can be performed in numerous ways. For example, receiving first information indicative of initiation of contention, second information indicative of the IFS interval, and/or third information indication of the backoff interval. The transmission interval determination unit 364 can determine (e.g., compute) an available interval T (a real number expressed in units of time) prior to transmission by using the first information, the second information, and/or the third information. In some aspects, T represents or otherwise indicates the interval available for sensing. A selection unit 368 can access (e.g., receive or retrieve) information representative or otherwise indicative of T, and can determine a sensing interval Δt based at least on T and/or a selection rule. The example apparatus 350 shown in FIG. 3B includes one or more memory devices 380 (referred to as memory 380) having one or more memory elements 384 (e.g., registers or other type of storage components). The memory element(s) 384 can be referred to as selection rule(s) 384 and include information indicative of one or more selection rules for adaptive determination of a sensing interval for MPD. Further, the memory 380 also can include one or more second memory elements 386 that include information indicative of a group of sensing times (e.g., the set S described herein) that the selection unit 368 can selected from in order to configure a sensing time for MPD. The example apparatus 350 also can include a mid-packet detection unit 370 that can receive or otherwise access information indicative of a sensing interval configured by the sensing time configuration unit 360, for example. In response to receiving or otherwise accessing such information, the mid-packet detection unit 370 can perform MPD (or clear assessment channel) using the sensing interval. In some embodiments, the mid-packet detection unit 370 can be embodied in or can include at least a portion of the circuitry shown in FIG. 2 and described herein. Thus, in some implementations, the mid-packet detection unit 370 can perform MPD using guard-interval symbol correlation as described herein. The mid-packet detection unit 370 is not limited in that regard and it can implement other types of clear channel assessments.

While illustrated as separate blocks, it is noted that some or all of the functional element (units, memory devices, memory elements, etc.) that constitute the example apparatus 350 can be integrated into a single unit (e.g., a single chipset or other type of solid state circuitry). In other embodiments, the memory 38 can be distributed amongst, and respectively integrated with, the sensing time configuration unit 360 and the mid-packet detection unit 370. Thus, in one example, first circuitry and second circuitry can formed, where the first circuitry can provide the functionality of the sensing time configuration unit 360 and the second circuitry can provide the functionality of the mid-packet detection unit 370.

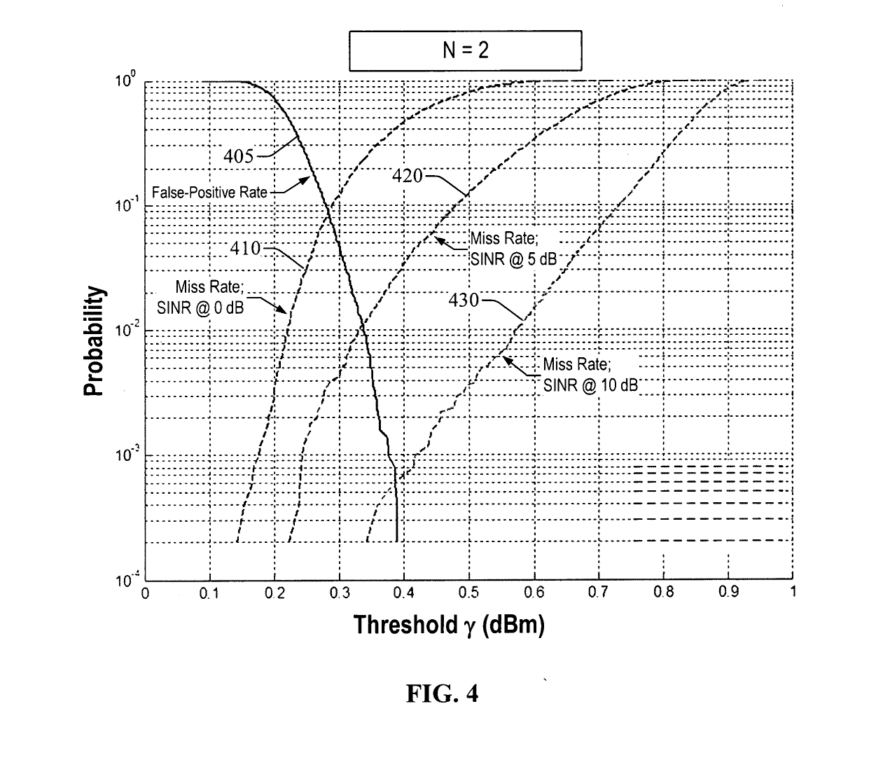

FIG. 4 illustrates examples of performance simulations of MPD in a network environment including devices that can communicate wirelessly, in accordance with one or more embodiments of the disclosure. In the network environment, propagation of wireless signaling is modeled according to non-line-of-sight propagation (NLoS), where path loss is modeled according to Model D for propagation within a communication channel. In addition or in some embodiments, the devices can transmit and/or receive wireless information (data, metadata, and/or signaling) according to an IEEE 802.11 protocol in a single-output single-input (SISO) mode. Each of the performance simulation is referred to as a physical layer (PHY) simulation and can be performed at a fixed sensing time of two symbols (e.g., N=2), for example. As it can be gleaned from the exemplified performance simulations, the performance under 0 dB signal-to-interference-and-noise ratio (SINR) can be stringent for capability requirement, and it may be possible that an actual implementation of MPD with such a fixed sensing time may not satisfy, for example, a 90% miss rate requirement or other types of stringent performance conditions (e.g., miss rate greater than about 90%). It is noted that the exemplified simulations also show that some optimizations may improve the MPD performance. Yet, such an optimization approach may be implementation specific, and thus, sensing time requirements within the formal specification of a radio technology protocol (e.g., IEEE 802.11 ax) may need to be significantly flexible (or, in colloquial terms, “loose”).

As mentioned herein, the threshold γ in MPD can be utilized to determine the presence or absence of a packet (e.g., a Wi-Fi signal) in a communication channel, such as a primary channel and/or a secondary channel. In a scenario in which the presence of the packet has been ascertained, the miss rate for MPD detection depends on the SINR of the packet (or, in some embodiments, packets) that are ascertained to be present in the communication channel. As such, as an illustration, FIG. 4 presents three traces 410, 420, and 430 for respective simulated miss rates, each associated with a specific SINR expressed in decibel (dB), for a fixed sensing time corresponding to N=2. Specifically, traces 410, 420, and 430 illustrate, respectively, simulated miss rates corresponding to incoming signal having SINR of about 0 dB, about 5 dB, and about 10 dB. As readily gleaned from the simulations, changes in the threshold γ at fixed sensing time (e.g., N=2) can result in different miss rate probabilities. Accordingly, in some embodiments, a particular value of γ (e.g., 0.3 dBm) can be configured for fixed sensing time for MPD. It is noted that for different sensing times for MPD, the value of γ can change.

From PHY simulations, such as those illustrated in FIG. 4, criteria for adaptive configuration of sensing time for MPD can be configured or otherwise determined. Such criteria can permit a particular selection of a sensing time for MPD, and as such, the criteria can be referred to as selection criteria. In some embodiments, selection criteria can defined or otherwise determined based at least on (a) one or more defined thresholds for SINR of incoming wireless signals (e.g., one or more packets) and/or (b) an upper bound for a satisfactory miss rate. As an illustration, a group of such criteria for adaptive MPD sensing can include the following:

Example criteria for adaptive selection of sensing time of 43 μs (e.g., N=2 symbols): 0≦SINR≦3 dB and miss rate 30%; and 3 dB≦SINR≦5 dB and miss rate 10%.

Second example criteria for adaptive selection of sensing time of 61 μs (e.g., N=3 symbols): 0≦SINR≦3 dB and miss rate 20%; and 3≦SINR≦5 dB miss rate 5%. Third example criteria for adaptive selection of sensing time of 70 μs (e.g., N=4 symbols): 0≦SINR≦3 dB and miss rate 10%; and 3≦SINR≦5 dB and miss rate 1%. The foregoing example criteria are just an illustration of adaptation of sensing times under stringent miss rates at low SINR. Thus, other criteria can be defined or otherwise utilized. As shown in FIG. 4, miss rate can be better than 10% or 20%. Therefore, as it can be gleaned from FIG. 4, in accordance with aspects of the disclosure, adaptive sensing provides satisfactory CCA performance even in scenarios in which low SINR detection probability is poor due to poor implementation.

Further or in some embodiments, the following example criteria for adaptive selection of idealized MPD sensing with 43 μs sensing time: 0≦SINR≦5 dB and miss rate 5%. According to some aspects, idealized MPD sensing refers to low miss rate (e.g., less than about 5%) when SINR is within 0 dB and about 3 dB.

It can be readily appreciated that the adaptive MPD can be adaptive with respect to particular conditions associated with received wireless signals and/or, in some embodiments, transmitted wireless signals, and/or an intended or otherwise satisfactory miss rate for ascertaining presence or absence of a packet in a communication (e.g., a primary channel and/or a second channel). Such conditions can be specified or otherwise determined by strength metrics of the wireless signal that is received and/or transmitted, where the strength metrics include SINR, received signal strength indicator (RSSI), received channel power indicator (RCPI), a combination thereof, or the like. While miss rate is utilized as a metric for establishing the presence or absence of a packet in a communication channel, other metrics, including false-alarm (or false-positive) rate, also may be utilized.

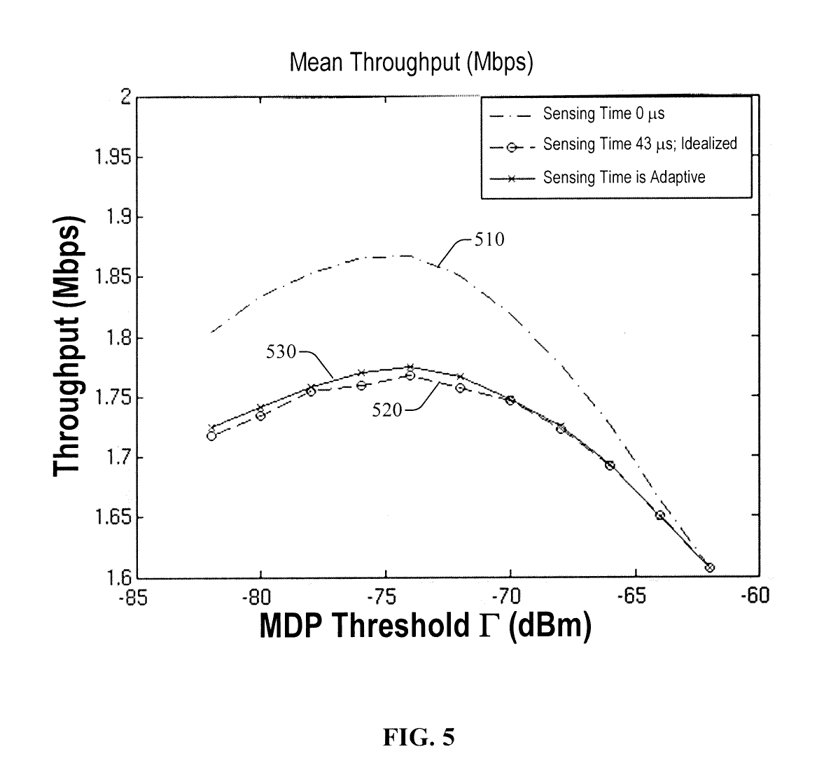

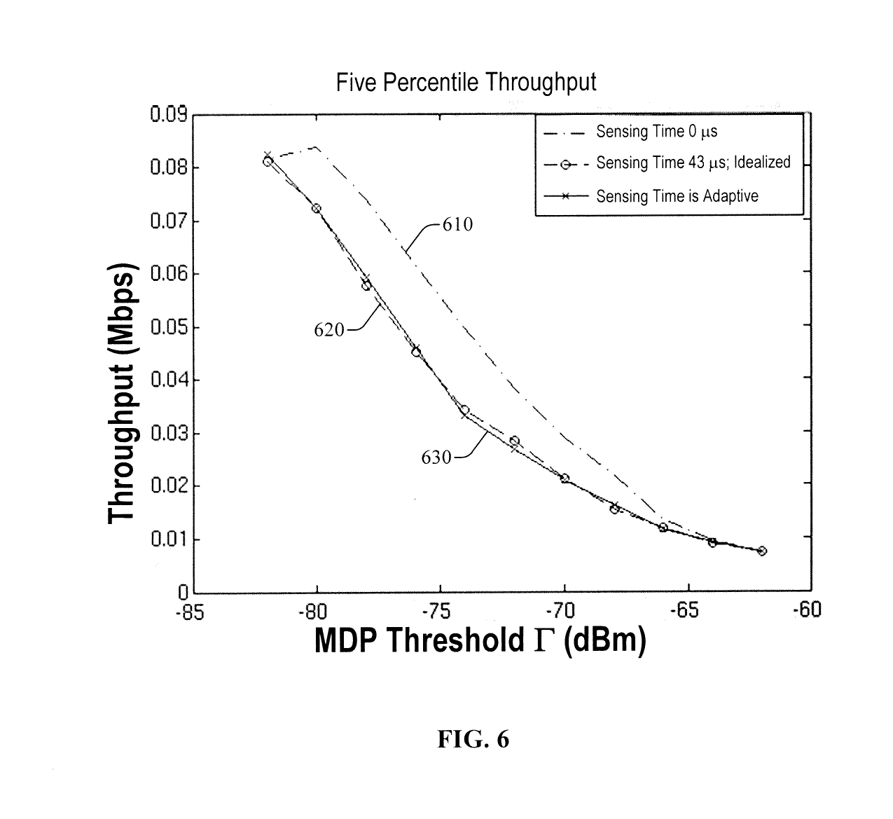

Based at least on the foregoing criteria for adaptive sensing, FIG. 5 illustrates another example performance simulation of mean throughput in a network of communications devices in accordance with one or more embodiments of the disclosure. The network of communication devices includes a multiunit dwelling building having five floors, each having a height of 3 meters and including 20 units in each floor. The size of each apartment is 10 m×10 m×3 m. Each apartment includes 10 STA devices and 1 AP device. The chart illustrates throughput (in Mbps) as a function of MPD threshold Γ. In at least some embodiments, F (which can be a positive real number) can be expressed in dBm. Here, dBm represents decibel-milliwatts, which is defined as 10 log₁₀(P/1 mW), where P indicates a power value. As mentioned herein, in some implementations, the presence or absence of the packet(s) can be ascertained, using, at least in part, a guard-interval correlation technique and a defined threshold γ. After presence of packet(s) is ascertained, the power of the packet(s) can be evaluated or otherwise considered in an assessment of whether a wireless transmission is feasible. More specifically, a channel (e.g., primary channel) can be deemed busy when the power of the packet(s) exceed the MPD threshold Γ, and can be deemed idle even the packet(s) are ascertained to be present in the channel. Accordingly, the MPD threshold Γ shown is FIG. 5 (and also FIG. 6) is a configurable threshold for the power of detected packet(s), and thus, the MPD threshold Γ can be different from the threshold γ. Further, the MPD threshold Γ can determine, at least in part, the throughput of a group of communication devices, as shown in FIGS. 5-6. In FIG. 5, trace 510 is indicative of simulated performance at a theoretical sensing time of 0 μs—e.g., wireless Wi-Fi signal can be detected instantaneously—and trace 520 is indicative of simulated performance under fixed sensing time according to the idealized criteria set forth above—in which, for example, sensing time is configured to be 43 μs. Trace 530 is indicative of simulated performance in a scenario in which adaptive sensing is implemented for MPD in accordance with this disclosure. As it can be gleaned from the simulation, adaptive sensing provides a mean throughput performance that is essentially the same, or at least comparable to, the mean throughput performance of MPD in an idealized scenario.

FIG. 6 illustrates other examples of performance simulations in the network of communication devices utilized in the simulations shown in FIG. 5. The illustrated performance corresponds to throughput for the five percentile of communication devices in the simulated network in different scenarios for MPD sensing: (1) theoretical sensing at 0 μs sensing time; (2) idealized sensing at fixed sensing time of 43 μs (see foregoing example criteria for idealized sensing); and (3) adaptive sensing for MPD with adaptive times (see foregoing example criteria for adaptive sensing times). As it can be gleaned, the simulated performances in the idealized scenario and under adaptive sensing time for MPD described herein are essentially the same, or at the very least are comparable. Thus, it can be concluded that the mean throughput illustrated in FIG. 5 is not the result of simulation artifact(s), but rather the efficiencies afforded by the adaptive sensing time described herein.

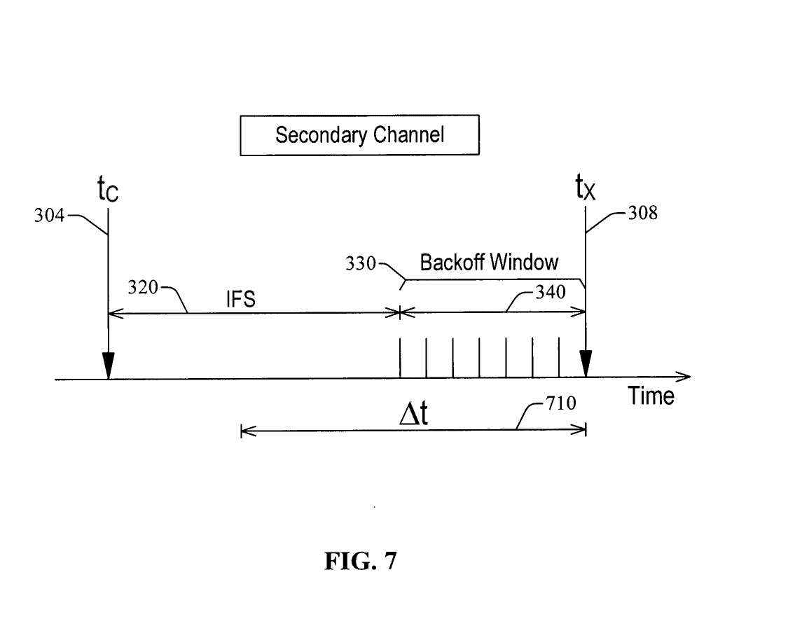

FIG. 7 illustrates an example of adaptive MPD sensing in the secondary channel in accordance with one or more embodiments of the disclosure. As illustrated a STA device can perform MPD during a defined period Δt 710 (e.g., 43 μs, 61 μs, or 70 μs) before a transmission on a secondary channel, where Δt is the selected sensing time. In accordance with aspects of this disclosure, in at least some implementations, Δt 710 can correspond to an interval spanned by a defined number of OFDM symbols, and can be selected according to defined criteria, such as the example criteria described herein. More specifically, in some implementations, the sensing time Δt 710 can be adapted to SINR conditions for detection of signal within the second channel and a desired or otherwise satisfactory miss rate. Accordingly, in one example, Δt 710 can be selected from a group comprising times Δt₀, Δt₁, . . . , Δt_{M}, respectively associated with a first SINR condition and first threshold miss rate, a second SINR condition and second miss rate, and so forth up to an M-th SINR condition and an M-th miss rate. Here, M is a natural number greater than unity. The i-th SINR condition (e.g., S≦SINR≦S′) and the i-th miss rate μ can embody or otherwise constitute a defined criteria for selection of the a sensing time Δtᵢ, where 1≦i≦M.

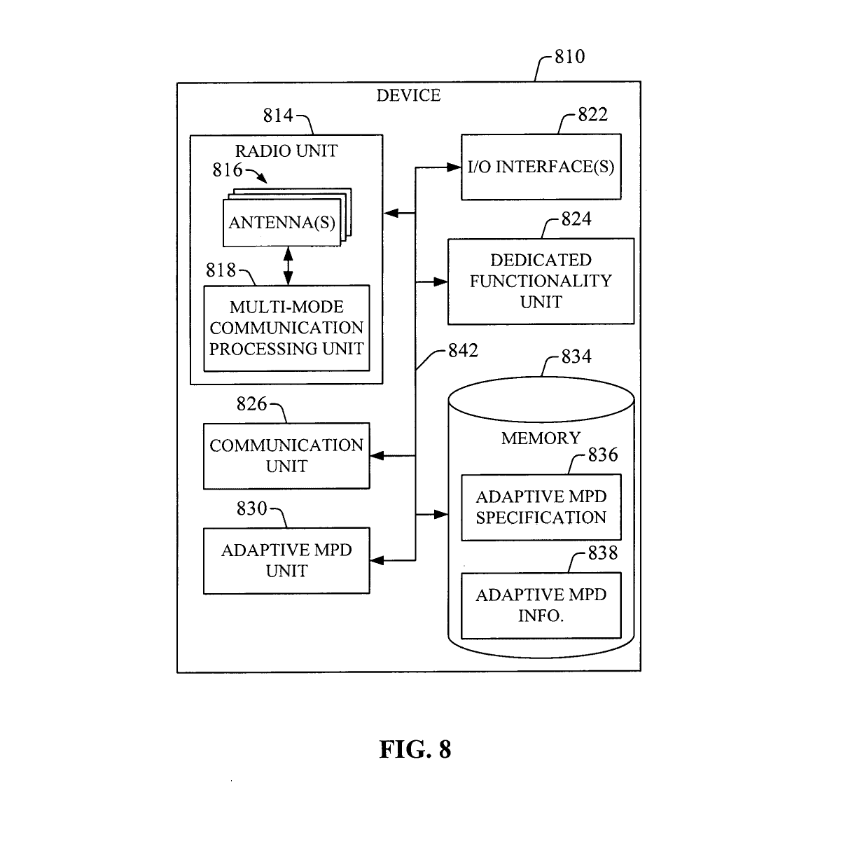

FIG. 8 illustrates a block diagram of an example embodiment of a device 810 that can operate in accordance with at least some aspects of the disclosure. In some aspects, the device 810 can provide one or more specific functionalities—such as operating as a digital camera and generating digital images (e.g., static pictures and/or motion pictures); operating as a navigation device; operating as a biometric device (e.g., a heart rate monitor, a pressure monitor, a glucometer, an iris analyzer, a fingerprint analyzer, etc.); dosing and delivering an amount of a drug or other compound for a defined therapy; operating as a sensor and sensing a defined quantity, such as temperature and/or pressure, or motion; operating as another sensor and sensing a compound in gas phase or liquid phase; operating as a controller for configuring a second defined physical quantity, managing energy, managing access to an environment, managing illumination and/or sound, regulating a defined process, such an automation control process, or the like; generating current, voltage, or other type of signal via inductive coils; a combination of the foregoing; a derivative functionality of the foregoing; or the like. To that end, the device 810 can include one or more functionality units 824 (referred to as dedicated functionality unit 824) that can include optical elements (e.g., lenses, collimators, light guides, light sources, light detectors (such as semiconductor light detectors), focusing circuitry, etc.); temperature sensors; pressure sensors; gas sensors; motion sensors, including inertial sensors (such as linear accelerator and/or a gyroscope); mechanical actuators (such as locks, valves, and the like); a combination of the foregoing; or the like. In some aspects, a specific functionality of the device 810 can include one or more processors (not depicted in FIG. 8) that can constitute the dedicated functionality unit 824. In some implementations, at least one of the processor(s) can receive and operate on data or other type of information (e.g., analog signals) generated by components of the dedicated functionality unit 824. The at least one processor can execute a module in order to operate on the data and/or other type of information and, as a result, provide a defined functionality. The module can be embodied in or can include, for example, a software application stored in a memory device integrated into or functionally coupled to the device. For instance, the module can be retained in one or more memory elements (not shown) within one or more other memory devices 834 (collectively referred to as memory 834). In addition or in other implementations, at least a second one of the processor(s) can control the operation or duty cycle of a portion of the dedicated functionality unit 824 so as to collect data and/or other type of information; provide an amount (or a dose) of a compound or acquire another amount of another compound or material; or a combination thereof. At least one of the functionality units that constitute the dedicated functionality unit 824 can generate control signals (e.g., interruptions, alarms, or the like) and/or can cause the device 810 to transition between operational states in response to a defined condition of the device 810 or its environment. At least some of the control signals can be sent to an external device (not depicted in FIG. 8) via an I/O interface of the I/O interfaces 822. The type and/or number of components included in the dedicated functionality unit 824 can establish, at least in part, the complexity of the device 810. In some examples, the device 810 can embody or can constitute a sensor hub.

In addition or in other aspects, the device 810 can operate as a wireless device and can embody or can constitute an access point device, a mobile computing device (e.g., user equipment or station device), or other types of communication device that can transmit and/or receive wireless signal embodying or otherwise constituting wireless communications in accordance with this disclosure. To permit wireless communication, including the MPD with adaptive sensing time as described herein, the device 810 includes a radio unit 814, a communication unit 826, and an adaptive MPD unit 830. In some implementations, the communication unit 826 can generate packets or other types of information structure via a network stack, for example, and can convey the packets and/or the other types of information blocks to the radio unit 814 for wireless communication. In some embodiments, the network stack (not shown) can be embodied in or can constitute a library or other types of programming modules, and the communication unit 826 can execute the network stack in order to generate a packet or other types of information block. To that end, in some implementations, the communication unit 826 can include one or more processors configured to access and/or execute the network stack. Generation of the packet or the other types of information blocks can include, for example, generation of control information (e.g., checksum data, communication address(es)), traffic information (e.g., payload data), and/or formatting of such information into a specific packet header, frame, or the like.

The adaptive MPD unit 830 can operate in accordance with aspects described herein. To that end, in some implementations, the adaptive MPD unit 830 can determine an interval prior to a transmission of wireless signal. As described herein, the interval can be the difference between a first instant (e.g., t_{C} 304) at which the device can initiate contention for communication resources and a second instant (e.g., t_{X} 308) at which a defined backoff period (backoff interval 340) is expected to elapse. The backoff period can include a number of time slots that can be determined randomly or according to a defined procedure. As such, the backoff period can correspond to a defined slot time (e.g., 9 μs) multiplied by the number of slots constituting the backoff period. In some implementations, the communication unit 826 can determine the backoff period. The adaptive MPD unit 830 also can determine a sensing period for MPD. For example, the adaptive MPD unit 830 can select a sensing time using at least one or more of the determined interval or a selection rule, and can configure the sensing time as the sensing period for MPD. As described herein, the interval can include an interframe spacing period corresponding to at least one of a short interframe space (SIFS) or an arbitration interframe space (AIFS), and the sensing time is less than the interval.

The adaptive MPD unit 830 can select the sensing period for MPD in numerous ways. In one example, the adaptive MPD unit 830 can obtain (e.g., retrieve or otherwise access) the sensing time from one or more memory elements 838 retained in one or more memory devices 834 (referred to as memory 834). The memory element(s) 838 are referred to as adaptive MPD information 838 and can include a group of defined (e.g., predetermined) sensing times. As described herein, the group (e.g., the set S) can include a maximum permissible sensing time and other times in a range from about 40 μs to about 100 μs. For instance, the group of times can include 43 μs, 61 μs, and 70 μs. As described herein, at least some of the times in the group of sensing times can include correspond to a first interval spanned by two OFDM symbols in a radio communication protocol, a second interval spanned by three OFDM symbols in the radio communication protocol, and a third interval spanned by four OFDM symbols in the radio communication protocol. In one implementation, an OFDM symbol of the two OFDM symbols, the three OFDM symbols, and/or the four OFDM symbols can have a symbol duration equal to about 12.4 μs plus a defined guard interval. Regardless of the specific configuration of the group of sensing times, the adaptive sensing time 830 can select one of the times included in such a group.

In addition or in some embodiments, as described herein, the selection rule can be based on a signal strength threshold (e.g., a maximum SINR) and a detection performance threshold (e.g., miss rate less than about 10%). In some aspects, the selection rule also can be based on a second signal strength threshold (e.g., a minimum SINR). The adaptive MPD unit 830 can obtain the selection rule from one or more memory elements 836 retained in the memory 834. The memory element(s) 836 can be referred to as adaptive MPD specification 836, and can include information that specifies (e.g., that is indicative or representative) of selection rules.

Further or in some other embodiments, the adaptive MPD unit 830 can implement mid-packet detection using the sensing time. Thus, in one example, the adaptive MPD unit 830 can include at least a portion of the receiver circuitry shown in FIG. 2. As described herein, the MPD can be performed in at least one of a primary communication channel or a secondary communication channel. The adaptive MPD unit 830 also can select a threshold (e.g., γ) to ascertain presence of wireless signal during the implementation of the MPD, where the threshold can be based on the detection performance threshold.

In some embodiments, the adaptive MPD unit 830 can include the sensing time configuration unit 360 and the mid-packet detection unit 370 shown in FIG. 3 and described herein. Thus, in some aspects, the functionalities of the adaptive MPD unit 830 can be provided or otherwise facilitated, at least in part, by such units. In at least one of those embodiments, the memory 380 can constitute, for example, the memory 834.

As illustrated, the radio unit 814 can include one or more antennas 816 and a multi-mode communication processing unit 818. In some embodiments, the antenna(s) 816 can be embodied in or can include directional or omnidirectional antennas, including, for example, dipole antennas, monopole antennas, patch antennas, loop antennas, microstrip antennas or other types of antennas suitable for transmission of RF signals. In addition or in other embodiments, at least some of the antenna(s) 816 can be physically separated to leverage spatial diversity and related different channel characteristics associated with such diversity. Further or in yet other embodiments, the multi-mode communication processing unit 818 that can process at least wireless signals in accordance with one or more radio technology protocols and/or modes (such as MIMO, single-input-multiple-output (SIMO), multiple-input-single-output (MISO), and the like. Each of such protocol(s) can be configured to communicate (e.g., transmit, receive, or exchange) data, metadata, and/or signaling over a specific air interface. The one or more radio technology protocols can include 3GPP UMTS; LTE; LTE-A; Wi-Fi protocols, such as those of the IEEE) 802.11 family of standards; Worldwide Interoperability for Microwave Access (WiMAX); radio technologies and related protocols for ad hoc networks, such as Bluetooth or ZigBee; other protocols for packetized wireless communication; or the like). The multi-mode communication processing unit 818 also can process non-wireless signals (analog signals, digital signals, a combination thereof, or the like).

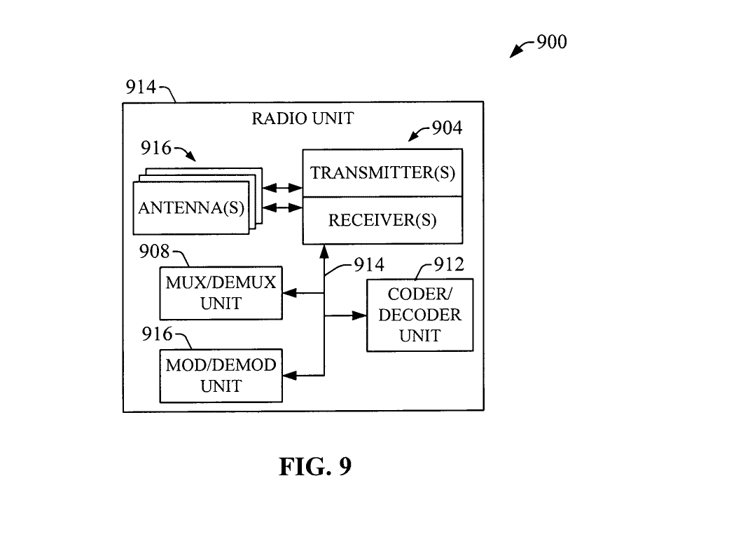

In one embodiment, e.g., example embodiment 900 shown in FIG. 9, the multi-mode communication processing unit 818 can include a set of one or more transmitters/receivers 904, and components therein (amplifiers, filters, analog-to-digital (A/D) converters, etc.), functionally coupled to a multiplexer/demultiplexer (mux/demux) unit 908, a modulator/demodulator (mod/demod) unit 916 (also referred to as modem 916), and a coder/decoder unit 912 (also referred to as codec 912). Each of the transmitter(s)/receiver(s) can form respective transceiver(s) that can transmit and receive wireless signal (e.g., electromagnetic radiation) via the one or more antennas 816. It is noted that in other embodiments, the multi-mode communication processing unit 818 can include, for example, other functional elements, such as one or more control units (e.g., a memory controller), an offload engine or unit, I/O interfaces, baseband processing circuitry, a combination of the foregoing, or the like. While illustrated as separate blocks in the device 810, it is noted that in some embodiments, at least a portion of the multi-mode communication processing unit 818 and one or more of the communication unit 826 or the adaptive MPD unit 830 can be integrated into a single unit—e.g., a single chipset or other type of solid state circuitry. In some aspects, such a single unit can be configured by programmed instructions retained in the memory 834 and/or other memory devices integrated into or functionally coupled to the unit.

Electronic components and associated circuitry, such as mux/demux unit 908, codec 912, and modem 916 can permit or otherwise facilitate processing and manipulation, e.g., coding/decoding, deciphering, and/or modulation/demodulation, of signal(s) received by the device 810 and signal(s) to be transmitted by the device 810. In one aspect, as described herein, received and transmitted wireless signals can be modulated and/or coded, or otherwise processed, in accordance with one or more radio technology protocols. Such radio technology protocol(s) can include 3GPP UMTS; 3GPP LTE; LTE-A; Wi-Fi protocols, such as IEEE 802.11 family of standards (IEEE 802.ac, IEEE 802.ax, and the like); WiMAX; radio technologies and related protocols for ad hoc networks, such as Bluetooth or ZigBee; other protocols for packetized wireless communication; or the like.

The electronic components in the multi-mode communication processing unit, including the one or more transmitters/receivers 904, can exchange information (e.g., data, metadata, code instructions, signaling and related payload data, combinations of the foregoing, or the like) through a bus 914, which can embody or can include at least one of a system bus, an address bus, a data bus, a message bus, a reference link or interface, a combination thereof, or the like. Each of the one or more receivers/transmitters 904 can convert signal from analog to digital and vice versa. In addition or in the alternative, the receiver(s)/transmitter(s) 904 can divide a single data stream into multiple parallel data streams, or perform the reciprocal operation. Such operations may be conducted as part of various multiplexing schemes. As illustrated, the mux/demux unit 908 is functionally coupled to the one or more receivers/transmitters 904 and can permit processing of signals in time and frequency domain. In one aspect, the mux/demux unit 908 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 908 can scramble and spread information (e.g., codes) according to most any code, such as Hadamard-Walsh codes, Baker codes, Kasami codes, polyphase codes, and the like. The modem 916 can modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like). In addition, processor(s) that can be included in the device 810 (e.g., processor(s) included in the radio unit 814 or other functional element(s) of the device 810) can permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 912 can operate on information (e.g., data, metadata, signaling, or a combination thereof) in accordance with one or more coding/decoding schemes suitable for communication, at least in part, through the one or more transceivers formed from respective transmitter(s)/receiver(s) 904. In some aspects, such coding/decoding schemes, or related procedure(s), can be retained as computer-accessible instructions (computer-readable instructions, computer-executable instructions, or a combination thereof) in one or more memory devices 834 (collective referred to as memory 834) and/or other memory device integrated into or otherwise functionally coupled to the radio unit 814. In a scenario in which wireless communication among the device 810 and another computing device (e.g., a station or other types of user equipment) utilizes MIMO, MISO, SIMO, or SISO operation, the codec 912 can implement at least one of space-time block coding (STBC) and associated decoding, or space-frequency block (SFBC) coding and associated decoding. In addition or in other scenarios, the codec 912 can extract information from data streams coded in accordance with spatial multiplexing scheme. In one aspect, to decode received information (e.g., data, metadata, signaling, or a combination thereof), the codec 912 can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 912 can utilize, at least in part, mux/demux unit 908 and mod/demod unit 916 to operate in accordance with aspects described herein.

With further reference to FIG. 8, the device 810 can operate in a variety of wireless environments having wireless signals conveyed in different electromagnetic radiation (EM) frequency bands. To at least such end, the multi-mode communication processing unit 818 in accordance with aspects of the disclosure can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion(s) of the EM spectrum. In one aspect, the set of one or more frequency bands can include at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

The device 810 can receive and/or transmit information encoded and/or modulated or otherwise processed in accordance with aspects of the present disclosure. To at least that end, in some embodiments, the device 810 can acquire or otherwise access information wirelessly via the radio unit 814 (also referred to as radio 814), where at least a portion of such information can be encoded and/or modulated in accordance with aspects described herein. As illustrated, in some embodiments, the device 810 can include one or more memory elements 836 (referred to adaptive MPD specification 836) that can include information defining or otherwise specifying an implementation of MPD (e.g., correlation mechanism). In addition or in other embodiments, the adaptive MPD specification 836 can specify instructions or criteria for mid-packet detection for a define sensing time, which can be adaptively selected as described herein. In addition, the device 810, via the communication unit 826, for example, can determine and/or configure adaptive sensing times and/or correlation thresholds for adaptive MPD based on groups of defined sensing times and/or performance criteria retained in in one or more memory elements 838 (referred to as adaptive MPD information 838). In one example, the adaptive MPD information also can include defined values of the threshold γ and/or values of MPD thresholds as described herein.

The memory 834 can contain one or more memory elements having information suitable for processing information received according to a predetermined communication protocol (e.g., IEEE 802.11 ac or IEEE 802.11 ax). While not shown, in some embodiments, one or more memory elements of the memory 834 can include computer-accessible instructions that can be executed by one or more of the functional elements of the device 810 in order to implement at least some of the functionality for adaptive mid-packet detection in wireless communication in accordance with aspects described herein. One or more groups of such computer-accessible instructions can embody or can constitute a programming interface that can permit communication of information (e.g., data, metadata, and/or signaling) between functional elements of the device 810 for implementation of such functionality.

As illustrated, the device 810 can include one or more I/O interfaces 822. At least one of the I/O interface(s) 822 can permit the exchange of information between the device 810 and another computing device and/or a storage device. Such an exchange can be wireless (e.g., via near field communication or optically-switched communication) or wireline. At least another one of the I/O interface(s) 822 can permit presenting information visually, aurally, and/or via movement to an end-user of the device 810. In one example, a haptic device can embody the I/O interface of the I/O interface(s) 822 that permit conveying information via movement. In addition, in the illustrated device 810, a bus architecture 842 (also referred to as bus 842) can permit the exchange of information (e.g., data, metadata, and/or signaling) between two or more functional elements of the device 810. For instance, the bus 842 can permit exchange of information between two or more of (i) the radio unit 814 or a functional element therein, (ii) at least one of the I/O interface(s) 822, (iii) the communication unit 826, or (iv) the memory 834. In addition, one or more application programming interfaces (APIs) (not depicted in FIG. 8A) or other types of programming interfaces that can permit exchange of information (e.g., data and/or metadata) between two or more of the functional elements of the device 810. At least one of such API(s) can be retained or otherwise stored in the memory 834. It is noted that, in some embodiments, at least one of the API(s) or other programming interfaces can permit the exchange of information within components of the communication unit 826. The bus 842 also can permit a similar exchange of information. In some embodiments, the bus 852 can embody or can include at least one of a system bus, an address bus, a data bus, a message bus, a reference link or interface, a combination thereof, or the like. In addition or in other embodiments, the bus 852 can include, for example, components for wireline and wireless communication.

It should be appreciated that portions of the device 810 can embody or can constitute an apparatus. For instance, the multi-mode communication processing unit 818, the communication unit 826, the adaptive MPD unit 830, and at least a portion of the memory 834 can embody or can constitute an apparatus that can operate in accordance with one or more aspects of this disclosure.

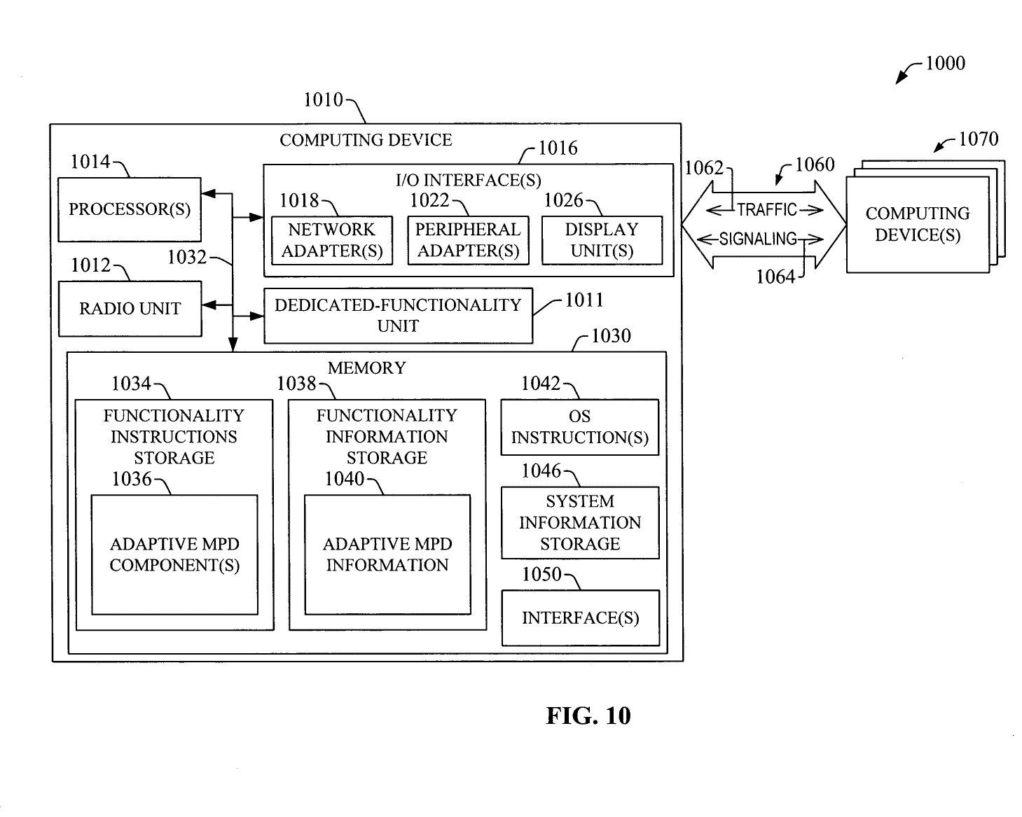

FIG. 10 illustrates an example of a computational environment 1000 for wireless communication in accordance with one or more aspects of the disclosure. The example computational environment 1000 is only illustrative and is not intended to suggest or otherwise convey any limitation as to the scope of use or functionality of such computational environments' architecture. In addition, the computational environment 1000 should not be interpreted as having any dependency or requirement relating to any one or combination of components illustrated in this example computational environment. The illustrative computational environment 1000 can embody or can include, for example, the computing device 100, one or more of the base stations 114a, 114b, or 114c, and/or any other computing device (e.g., device 810) that can implement or otherwise leverage the adaptive mid-packet detection aspects described herein.

The computational environment 1000 represents an example of a software implementation of the various aspects or features of the disclosure in which the processing or execution of operations described in connection with the adaptive mid-packet detection in wireless communications in accordance with aspects described herein can be performed in response to execution of one or more software components at the computing device 1010. It should be appreciated that the one or more software components can render the computing device 1010, or any other computing device that contains such components, a particular machine for adaptive mid-packet detection in wireless communication in accordance with aspects described herein, among other functional purposes. A software component can be embodied in or can include one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible (or processor-accessible) instructions that embody a software component can be assembled into one or more program modules, for example, that can be compiled, linked, and/or executed at the computing device 1010 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 1010 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the adaptive mid-packet detection features can include personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 1010 can include one or more processors 1014, one or more input/output (I/O) interfaces 1016, a memory 1030, and a bus architecture 1032 (also termed bus 1032) that functionally couples various functional elements of the computing device 1010. As illustrated, the computing device 1010 also can include a radio unit 1012. In one example, similarly to the radio unit 814, the radio unit 1012 can include one or more antennas and a communication processing unit that can permit wireless communication between the computing device 1010 and another device, such as one of the computing device(s) 1070. The computing device 1010 also can include, in at least some embodiments, a dedicate functionality unit 1011 that can provide specific functionality to the computing device 1010, similarly to the dedicated functionality unit 824 described hereinbefore. The bus 1032 can include at least one of a system bus, a memory bus, an address bus, or a message bus, and can permit exchange of information (data, metadata, and/or signaling) between the processor(s) 1014, the I/O interface(s) 1016, and/or the memory 1030, or respective functional element therein. In some scenarios, the bus 1032 in conjunction with one or more internal programming interfaces 1050 (also referred to as interface(s) 1050) can permit such exchange of information. In scenarios in which processor(s) 1014 include multiple processors, the computing device 1010 can utilize parallel computing.

The I/O interface(s) 1016 can permit or otherwise facilitate communication of information between the computing device and an external device, such as another computing device, e.g., a network element or an end-user device. Such communication can include direct communication or indirect communication, such as exchange of information between the computing device 1010 and the external device via a network or elements thereof. As illustrated, the I/O interface(s) 1016 can include one or more of network adapter(s) 1018, peripheral adapter(s) 1022, and display unit(s) 1026. Such adapter(s) can permit or facilitate connectivity between the external device and one or more of the processor(s) 1014 or the memory 1030. In one aspect, at least one of the network adapter(s) 1018 can couple functionally the computing device 1010 to one or more computing devices 1070 via one or more traffic and signaling pipes 1060 that can permit or facilitate exchange of traffic 1062 and signaling 1064 between the computing device 1010 and the one or more computing devices 1070. Such network coupling provided at least in part by the at least one of the network adapter(s) 1018 can be implemented in a wired environment, a wireless environment, or both. Therefore, it should be appreciated that in some embodiments, the functionality of the radio unit 1012 can be provided by a combination of at least one of the network adapter(s) 1018 and at least one of the processor(s) 1014. Accordingly, in such embodiments, the radio unit 1012 may not be included in the computing device 1010. The information that is communicated by the at least one network adapter can result from implementation of one or more operations in a method of the disclosure. Such output can be any form of visual representation, including, but not limited to, textual, graphical, animation, audio, tactile, and the like. In some scenarios, each of the computing device(s) 1070 can have substantially the same architecture as the computing device 1010. In addition or in the alternative, the display unit(s) 1026 can include functional elements (e.g., lights, such as light-emitting diodes; a display, such as liquid crystal display (LCD), combinations thereof, or the like) that can permit control of the operation of the computing device 1010, or can permit conveying or revealing operational conditions of the computing device 1010.

In one aspect, the bus 1032 represents one or more of several possible types of bus structures, including a memory bus or memory controller, a peripheral bus, an accelerated graphics port, and a processor or local bus using any of a variety of bus architectures. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 1032, and all buses described herein can be implemented over a wired or wireless network connection and each of the subsystems, including the processor(s) 1014, the memory 1030 and memory elements therein, and the I/O interface(s) 1016 can be contained within one or more remote computing devices 1070 at physically separate locations, connected through buses of this form, in effect implementing a fully distributed system.

The computing device 1010 can include a variety of computer-readable media. Computer readable media can be any available media (transitory and non-transitory) that can be accessed by a computing device. In one aspect, computer-readable media can include computer non-transitory storage media (or computer-readable non-transitory storage media) and communications media. Example computer-readable non-transitory storage media can be any available media that can be accessed by the computing device 1010, and can include, for example, both volatile and non-volatile media, and removable and/or non-removable media. In one aspect, the memory 1030 can include computer-readable media in the form of volatile memory, such as random access memory (RAM), and/or non-volatile memory, such as read only memory (ROM).

The memory 1030 can include functionality instructions storage 1034 and functionality information storage 1038. The functionality instructions storage 1034 can include computer-accessible instructions that, in response to execution (by at least one of the processor(s) 1014), can implement one or more of the functionalities of the disclosure. The computer-accessible instructions can embody or can include one or more software components illustrated as adaptive MPD component(s) 1036. In one scenario, execution of at least one component of the adaptive MPD component(s) 1036 can implement one or more of the techniques disclosed herein. For instance, such execution can cause a processor that executes the at least one component to carry out a disclosed example method. It should be appreciated that, in one aspect, a processor of the processor(s) 1014 that executes at least one of the adaptive MPD component(s) 1036 can retrieve information from or retain information in a memory element 1040 in the functionality information storage 1038 in order to operate in accordance with the functionality programmed or otherwise configured by the adaptive MPD component(s) 1036. Such information can include at least one of code instructions, information structures, or the like. At least one of the one or more interfaces 1050 (e.g., application programming interface(s)) can permit or facilitate communication of information between two or more components within the functionality instructions storage 1034. The information that is communicated by the at least one interface can result from implementation of one or more operations in a method of the disclosure. In some embodiments, one or more of the functionality instructions storage 1034 and the functionality information storage 1038 can be embodied in or can include removable/non-removable, and/or volatile/non-volatile computer storage media.

At least a portion of at least one of the adaptive MPD component(s) 1036 or adaptive MPD information 1040 can program or otherwise configure one or more of the processors 1014 to operate at least in accordance with the functionality described herein. One or more of the processor(s) 1014 can execute at least one of such components and leverage at least a portion of the information in the storage 1038 in order to provide adaptive MPD in accordance with one or more aspects described herein. More specifically, yet not exclusively, execution of one or more of the component(s) 1036 can permit transmitting and/or receiving information at the computing device 1010, where the at least a portion of the information includes a group of defined sensing times that can be adaptively selected in accordance with aspects of this disclosure. As such, it should be appreciated that in some embodiments, a combination of the processor(s) 1014, the adaptive MPD component(s) 1036, and the adaptive MPD information 1040 can form means for providing specific functionality for adaptive mid-packet detection wireless communications in accordance with one or more aspects of the disclosure.

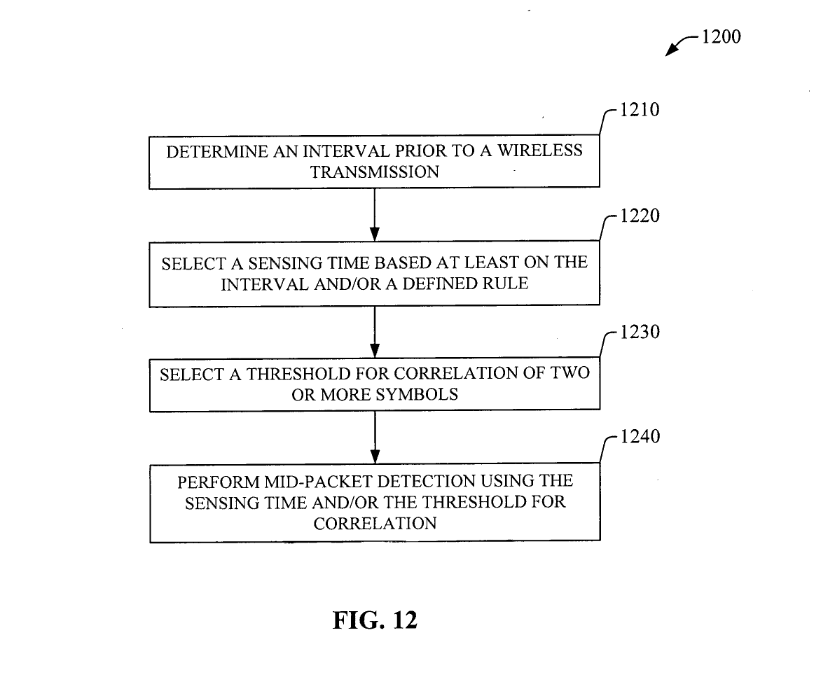

It should be appreciated that, in some scenarios, the functionality instruction(s) storage 1034 can embody or can include a computer-readable non-transitory storage medium having computer-accessible instructions that, in response to execution, cause at least one processor (e.g., one or more of processor(s) 1014) to perform a group of operations comprising the operations or blocks described in connection with the disclosed methods, such as the example method 1200 presented in FIG. 12.

In addition, the memory 1030 can include computer-accessible instructions and information (e.g., data and/or metadata) that permit or facilitate operation and/or administration (e.g., upgrades, software installation, any other configuration, or the like) of the computing device 1010. Accordingly, as illustrated, the memory 1030 can include a memory element 1042 (labeled OS instruction(s) 1042) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 1010 can dictate a suitable OS. The memory 1030 also comprises a system information storage 1046 having data and/or metadata that permits or facilitate operation and/or administration of the computing device 1010. Elements of the OS instruction(s) 1042 and the system information storage 1046 can be accessible or can be operated on by at least one of the processor(s) 1014.

It should be recognized that while the functionality instructions storage 1034 and other executable program components, such as the operating system instruction(s) 1042, are illustrated herein as discrete blocks, such software components can reside at various times in different memory components of the computing device 1010, and can be executed by at least one of the processor(s) 1014. In some scenarios, an implementation of the adaptive MPD component(s) 1036 can be retained on or transmitted across some form of computer readable media.

The computing device 1010 and/or one of the computing device(s) 1070 can include a power supply (not shown), which can power up components or functional elements within such devices. The power supply can be a rechargeable power supply, e.g., a rechargeable battery, and it can include one or more transformers to achieve a power level suitable for operation of the computing device 1010 and/or one of the computing device(s) 1070, and components, functional elements, and related circuitry therein. In some scenarios, the power supply can be attached to a conventional power grid to recharge and ensure that such devices can be operational. In one aspect, the power supply can include an I/O interface (e.g., one of the network adapter(s) 1018) to connect operationally to the conventional power grid. In another aspect, the power supply can include an energy conversion component, such as a solar panel, to provide additional or alternative power resources or autonomy for the computing device 1010 and/or one of the computing device(s) 1070.

The computing device 1010 can operate in a networked environment by utilizing connections to one or more remote computing devices 1070. As an illustration, a remote computing device can be a personal computer, a portable computer, a server, a router, a network computer, a peer device or other common network node, and so on. As described herein, connections (physical and/or logical) between the computing device 1010 and a computing device of the one or more remote computing devices 1070 can be made via one or more traffic and signaling pipes 1060, which can include wireline link(s) and/or wireless link(s) and several network elements (such as routers or switches, concentrators, servers, and the like) that form a PAN, a LAN, a WAN, a WPAN, a WLAN, and/or a WWAN. Such networking environments are conventional and commonplace in dwellings, offices, enterprise-wide computer networks, intranets, local area networks, and wide area networks.

It should be appreciated that portions of the computing device 1010 can embody or can constitute an apparatus. For instance, at least one of the processor(s) 1014; at least a portion of the memory 1030, including a portion of the adaptive MPD component(s) 1036 and a portion of the adaptive MPD information 1040; and at least a portion of the bus 1032 can embody or can constitute an apparatus that can operate in accordance with one or more aspects of this disclosure.

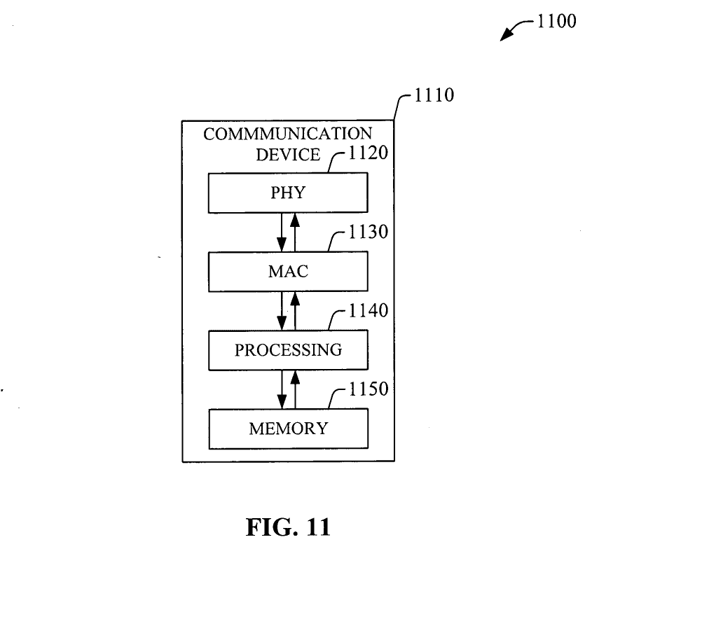

FIG. 11 presents another example embodiment 1100 of a communication device 1110 in accordance with one or more embodiments of the disclosure. The communication device 1110 can embody or can include, for example, one of the communication devices 110a, 110b, or 110c; one or more of the base stations 114a, 114b, or 114c; and/or any other computing device (e.g., communication device 810) that implements or otherwise leverages the adaptive mid-packet detection features described herein. In some embodiments, the communication device 1110 can be a HEW-compliant device that may be configured to communicate with one or more other HEW devices and/or other types of communication devices, such as legacy communication devices. HEW devices and legacy devices also may be referred to as HEW stations (HEW STAs) and legacy STAs, respectively. In one implementation, the communication device 1110 can operate as an access point (such as AP 114a, 114b, or 114c). As illustrated, the communication device 1110 can include, among other things, physical layer circuitry 1120 and medium-access-control layer (MAC) circuitry 1130. In one aspect, the PHY circuitry 1110 and the MAC circuitry 1130 can be HEW compliant layers and also can be compliant with one or more legacy IEEE 802.11 standards. In one aspect, the MAC circuitry 1130 can be arranged to configure physical layer converge protocol (PLCP) protocol data units (PPDUs) and arranged to transmit and receive PPDUs, among other things. In addition or in other embodiments, the communication device 1110 also can include other hardware processing circuitry 1140 (e.g., one or more processors) and one or more memory devices 1150 configured to perform the various operations described herein.

In some embodiments, the MAC circuitry 1130 can be arranged to contend for a wireless medium during a contention period to receive control of the medium for the HEW control period and configure an HEW PPDU. In addition or in other embodiments, the PHY circuitry 1120 can be arranged to transmit the HEW PPDU. The PHY circuitry 1120 can include circuitry for modulation/demodulation, upconversion/downconversion, filtering, amplification, etc. As such, the communication device 1110 can include a transceiver to transmit and receive data such as HEW PPDU. In some embodiments, the hardware processing circuitry 1140 can include one or more processors. The hardware processing circuitry 1140 can be configured to perform functions based on instructions being stored in a memory device (e.g., RAM or ROM) or based on special purpose circuitry. In some embodiments, the hardware processing circuitry 1140 can be configured to perform one or more of the functions described herein, such as allocating bandwidth or receiving allocations of bandwidth.

In some embodiments, one or more antennas may be coupled to or included in the PHY circuitry 1120. The antenna(s) can transmit and receive wireless signals, including transmission of HEW packets or other type of radio packets. As described herein, the one or more antennas can include one or more directional or omnidirectional antennas, including dipole antennas, monopole antennas, patch antennas, loop antennas, microstrip antennas or other types of antennas suitable for transmission of RF signals. In scenarios in which MIMO communication is utilized, the antennas may be physically separated to leverage spatial diversity and the different channel characteristics that may result.

The memory 1150 can retain or otherwise store information for configuring the other circuitry to perform operations for configuring and transmitting HEW packets or other types of radio packets, and performing the various operations described herein including, for example, adaptively determining a sensing time for MPD, configuring such a value, and performing MPD sensing using the determined (or otherwise selected) sensing time in accordance with one or more embodiments of this disclosure.

The communication device 1110 can be configured to communicate using OFDM communication signals over a multicarrier communication channel. More specifically, in some embodiments, the communication device 1110 can be configured to communicate in accordance with one or more specific radio technology protocols, such as the IEEE family of standards including IEEE 802.11, IEEE 802.11n, IEEE 802.11 ac, IEEE 802.11 ax, DensiFi, and/or proposed specifications for WLANs. In one of such embodiments, the communication device 1110 can utilize or otherwise rely on symbols having a duration that is four times the symbol duration of IEEE 802.11n and/or IEEE 802.11ac. It should be appreciated that the disclosure is not limited in this respect and, in some embodiments, the communication device 1110 also can transmit and/or receive wireless communications in accordance with other protocols and/or standards.

The communication device 1110 can be embodied in or can constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11 or IEEE 802.16, or other types of communication device that may receive and/or transmit information wirelessly. Similarly to the computing device 1010, the communication device 1110 can include, for example, one or more of a keyboard, a display, a non-volatile memory port, multiple antennas, a graphics processor, an application processor, speakers, and other mobile device elements. The display may be an LCD screen including a touch screen.

It should be appreciated that while the communication device 1110 is illustrated as having several separate functional elements, one or more of the functional elements may be combined and may be implemented by combinations of processing elements (software-configured or otherwise), such as processing components including digital signal processors (DSPs) and/or other hardware elements. For example, some processing elements may comprise one or more microprocessors, DSPs, field-programmable gate arrays (FPGAs), application specific integrated circuits (ASICs), radio-frequency integrated circuits (RFICs), complex instruction set computers (CISCs), reduced instruction set computing (RISC) devices, or combinations of various hardware and logic circuitry for performing at least the functions described herein in connection with adaptive MDP. In some embodiments, the functional elements may refer to one or more processes operating or otherwise executing on one or more processors. It should further be appreciated that portions of the communication device 1110 can embody or can constitute an apparatus. For instance, the processing circuitry 1140 and the memory 1150 can embody or can constitute an apparatus that can operate in accordance with one or more aspects of this disclosure. The apparatus also can include functional elements (e.g., a bus architecture and/or API(s) as described herein) that can permit exchange of information between the processing circuitry 1140 and the memory 1150.

In view of the functionalities described herein in accordance with this disclosure, various techniques can be implemented for adaptive MPD in wireless communications (e.g., UL transmissions and/or DL transmissions) by devices that can communicate wirelessly and can operate according to specific communication protocols (e.g., IEEE 802.11 standardized protocols). One example of such techniques can be better appreciated with reference, for example, to the flowchart in FIG. 12. For purposes of simplicity of explanation, the example method disclosed herein is presented and described as a series of blocks (with each block representing one or more actions or operations, for example). However, it is to be understood and appreciated that the illustrated method is not limited by the order of blocks and associated actions or operations, as some blocks may occur in different orders and/or concurrently with other blocks from those that are shown and described herein. For example, the various methods (or processes or techniques) in accordance with this disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes, or functionalities described herein in connection with adaptive mid-packet detection, can be implemented in combination with each other in order to accomplish one or more of the elements or advantages of this disclosure.

It is noted that the techniques of this disclosure can be retained on an article of manufacture, or computer-readable medium, to permit or facilitate transporting and transferring such methods to a computing device (e.g., a desktop computer; a mobile computer, such as a tablet, or a smartphone; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed techniques, can be employed to execute code instructions retained in a memory, or any computer- or machine-readable medium, to implement the one or more methods. The code instructions can provide a computer-executable or machine-executable framework to implement the techniques described herein.

FIG. 12 presents a flowchart of an example method 1200 for adaptive MPD in wireless communications in accordance with one or more embodiments of the present disclosure. A communication device (e.g., a station device or an access point device) or another type of device in accordance with aspects of this disclosure can implement (e.g., compile, link, and/or execute) the example method 1200 in its entirety or in part. For example, the device 810, the computing device 1010, and/or the communication device 1110 can implement one or more blocks of the example method 1200. It is noted that, in some aspect, the communication device or the other type of device that implements the example method 1200 can operate as a transmitter device (which can be referred to as a transmitter) when implementing the subject example method. As an illustration, any one of the devices 810, 1010, or 1110 can implement the example method 1200.

While illustrated with reference to a communication device, it should be appreciated that the subject example method 1200 also can be implemented by other types of apparatuses or devices in accordance with one or more aspects of the present disclosure. For example, one of such apparatuses can include at least one memory device having programmed instructions encoded or otherwise programmed thereon and at least one processor functionally coupled to the at least one memory and configured to execute the programmed instructions, where in response to execution of the programmed instructions, the at least one processor can perform or can facilitate performance of one or more blocks of the example method 1200. For another example, another one of such apparatuses can include circuitry assembled in a chipset (such as a CISC, a RISC chipset, an ASIC, and/or another type of processor) configured to implement at least the operations described in the example method 1200.

At block 1210, an available or otherwise expected interval prior to a wireless transmission can be determined by a communication device (e.g., device 110a or device 810) or a component thereof (e.g., circuitry integrated therein). As described herein, in one example, such an interval can be determined as the difference between an instant at which the communication device begins to contend for communication resources and an instant at which a last time slot of a backoff window is expected to elapse (see, e.g., FIG. 3 and related description).

At block 1220, the communication device or a component therein can select or otherwise determine a sensing time for MPD based at least on the available time interval and/or a defined rule (e.g., a selection criterion as described herein). In some implementations, the sensing time can be selected from a set of defined (e.g., preconfigured) sensing times, where the selected or otherwise determined sensing time can be the longest defined time compared to the available time interval. The set of defined sensing times can be retained or otherwise stored in a memory device of the communication device of the component therein. In other implementations, the sensing time can be selected using the defined rule and can be less than the longest defined time.

At block 1230, the communication device or a component therein can select a threshold for correlation (e.g., γ parameter shown FIG. 2 and described herein) of two or more symbols. The symbols can be received at the computing device from another device that can communicate wirelessly. As described herein, the threshold for correlation (e.g., the parameter γ) can be retained in a memory device of the communication device and/or the component therein. In some embodiments, while not shown, the example method 1200 also can include a block at which the communication device or the component therein can select a specific implementation (e.g., functions, parameters, etc.) of MPD other than the correlation technique described herein in connection with FIG. 2. At block 1240, the communication device or the component therein can perform MPD using the selected sensing time and/or the selected threshold for correlation.

The example method 1200 can be reiterated nearly continuously, periodically, or according to a defined schedule in order to select another sensing time as it may warranted by a current interval prior to transmission and/or other conditions in which the device that implements the example 1200 may be operating in. As such, sensing times can be adapted over time, and MPD can be implemented with such adapted sensing times, as described herein.

According to example embodiments of the disclosure, there may be an apparatus. The apparatus may include a least one memory that stores computer-executable instructions, and at least one processor configured to access the at least one memory, wherein the least one processor is configured to execute the computer-executable instructions to: determine an interval prior to a transmission, wherein the interval is the difference between a first instant at which the apparatus begins to contend for a communication resource and a second instant at which a defined backoff period is expected to elapse, select a sensing time based at least on one or more of the interval or a defined selection rule based on a signal strength threshold and a detection performance threshold; and direct implementation of mid-packet detection using the sensing time. The sensing time can be in a range from about 40 μs to about 100 μs, for example. In some aspects, the defined selection rule can be further based on a second signal strength threshold, and the at least one processor can be further configured to perform the mid-packet detection in at least one of a primary channel or a secondary channel.

Implementation may include one or more of the following elements. The interval prior to transmission can include an interframe spacing period, where the interframe spacing period may further correspond to at least one of a short interframe space (SIFS) period or an arbitration interframe space (AIFS) period. The interval may include a backoff period corresponding, for example, to a defined slot time multiplied by a defined number of slots constituting the backoff period. In some implementations, the sensing time may be less than the interval. In some embodiments, the apparatus can include a mid-packet detection unit that can implement the mid-packet detection using the sensing time, wherein the mid-packet detection unit selects a threshold to ascertain presence of wireless signal during the implementation of the mid-packet detection, and wherein the threshold is based on the detection performance threshold. In addition or in other embodiments, the at least one processor can be further configured to select the sensing time from a group consisting of 43 μs, 61 μs, and 70 μs. Further or in yet other embodiments, the sensing time may be selected from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol. In some implementations, The apparatus of claim 1, wherein the at least one processor is further configured to select the sensing time from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol. In some aspects, the radio communication protocol comprises a protocol from the IEEE 802.11ax standard. As such, in some examples, an OFDM symbol of the two OFDM symbols, the three OFDM symbols, or the four OFDM symbols has a symbol duration of equal to about 12.4 μs and a defined guard interval. The apparatus may further comprise a radio unit functionality coupled to the circuitry, wherein the radio unit is configured to receive wireless signal according to a define radio communication protocol. An antenna may be coupled to the radio unit.

According to example embodiments of the disclosure, there may be at least one computer-readable non-transitory storage medium. The at least one computer-readable non-transitory storage medium may have instructions encoded thereon that, in response to execution, cause at least one processor to perform operations comprising: determining an interval prior to a transmission, wherein the interval is the difference between a first instant at which the apparatus begins to contend for a communication resource and a second instant at which a defined backoff period is expected to elapse, selecting a sensing time based at least on one or more of the interval or a defined selection rule based on a signal strength threshold and a detection performance threshold, and implementing mid-packet detection using the sensing time.

Implementation may include one or more of the following elements. The interval period of the at least one computer-readable non-transitory storage medium may include an interframe spacing period. The interframe spacing period may further correspond to at least one of a short interframe space (SIFS) period or an arbitration interframe space (AIFS) period. The interval period of the medium may include a backoff period. The backoff period may further correspond to a defined slot time multiplied by a defined number of slots constituting the backoff period. The sensing time may be less than the interval. The defined selection rule may be based on a second signal strength threshold and in at least one of a primary channel or a secondary channel. The medium may further have instructions encoded thereon that, in response to execution, may cause at least one processor to perform operations comprising selecting a threshold to ascertain presence of wireless signal during implementation of the mid-packet detection, and wherein the threshold is based on the detection performance threshold. The sensing time of the medium may be selected from a range from 40 μs to about 100 μs or a group consisting of 43 μs, 61 μs, and 70 μs. The sensing time for the medium may be selected from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol. An OFDM symbol of the two, three or four OFDM symbols may have a symbol duration of equal to about 12.4 μs and a defined guard interval.

According to example embodiments of the disclosure, there may be a device. The device may include circuitry configured at least to: determine an interval prior to a transmission, wherein the interval is the difference between a first instant at which the apparatus begins to contend for a communication resource and a second instant at which a defined backoff period is expected to elapse, select a sensing time based at least on one or more of the interval or a defined selection rule based on a signal strength threshold and a detection performance threshold; and implement mid-packet detection using the sensing time.

Implementation may include one or more of the following elements. The interval period of the device may include an interframe spacing period. The interframe spacing period may further correspond to at least one of a short interframe space (SIFS) period or an arbitration interframe space (AIFS) period. The interval period of the device may include a backoff period. The backoff period may further correspond to a defined slot time multiplied by a defined number of slots constituting the backoff period. The sensing time may be less than the interval. The defined selection rule may be based on a second signal strength threshold and in at least one of a primary channel or a secondary channel. The device may further include circuitry configured to select a threshold to ascertain presence of wireless signal during implementation of the mid-packet detection, and wherein the threshold is based on the detection performance threshold. The sensing time of the device may be selected from a range from 40 μs to about 100 μs or a group consisting of 43 μs, 61 μs, and 70 μs. The sensing time may be selected from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol. An OFDM symbol of the two, three or four OFDM symbols may have a symbol duration of equal to about 12.4 μs and a defined guard interval. The device may further comprise a radio unit, wherein the radio unit is configured to receive wireless signal according to a define radio communication protocol. An antenna may be coupled to the radio unit.

According to example embodiments of the disclosure, there may be a method. The method may include operations comprising: determining an interval prior to a transmission, wherein the interval is the difference between a first instant at which the apparatus begins to contend for a communication resource and a second instant at which a defined backoff period is expected to elapse, selecting a sensing time based at least on one or more of the interval or a defined selection rule based on a signal strength threshold and a detection performance threshold, and implementing mid-packet detection using the sensing time.

Implementation may include one or more of the following elements. The interval period of the method may include an interframe spacing period. The interframe spacing period may further correspond to at least one of a short interframe space (SIFS) period or an arbitration interframe space (AIFS) period. The interval period of the method may include a backoff period. The backoff period may further correspond to a defined slot time multiplied by a defined number of slots constituting the backoff period. The sensing time may be less than the interval. The defined selection rule may be based on a second signal strength threshold and in at least one of a primary channel or a secondary channel. The method may further include operations comprising selecting a threshold to ascertain presence of wireless signal during implementation of the mid-packet detection, and wherein the threshold is based on the detection performance threshold. The sensing time of the method may be selected from a range from 40 μs to about 100 μs or a group consisting of 43 μs, 61 μs, and 70 μs. The sensing time may be selected from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol. An OFDM symbol of the two, three or four OFDM symbols may have a symbol duration of equal to about 12.4 μs and a defined guard interval.

According to example embodiments of the disclosure, there may be a system. The system may include operations comprising: means for determining an interval prior to a transmission, wherein the interval is the difference between a first instant at which the apparatus begins to contend for a communication resource and a second instant at which a defined backoff period is expected to elapse, means for selecting a sensing time based at least on one or more of the interval or a defined selection rule based on a signal strength threshold and a detection performance threshold, and means for implementing mid-packet detection using the sensing time.

Implementation may include one or more of the following elements. The interval period of the system may include an interframe spacing period. The interframe spacing period may further correspond to at least one of a short interframe space (SIFS) period or an arbitration interframe space (AIFS) period. The interval period of the system may include a backoff period. The backoff period may further correspond to a defined slot time multiplied by a defined number of slots constituting the backoff period. The sensing time may be less than the interval. The defined selection rule may be based on a second signal strength threshold and in at least one of a primary channel or a secondary channel. The system may further include operations comprising means for selecting a threshold to ascertain presence of wireless signal during implementation of the mid-packet detection, and wherein the threshold is based on the detection performance threshold. The sensing time of the system may be selected from a range from 40 μs to about 100 μs or a group consisting of 43 μs, 61 μs, and 70 μs. The sensing time may be selected from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol. An OFDM symbol of the two, three or four OFDM symbols may have a symbol duration of equal to about 12.4 μs and a defined guard interval.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or otherwise permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In some implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “architecture,” “interface,” “unit,” “module,” “engine,” “platform,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “architecture,” “interface,” “unit,” “engine,” “platform,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (such as, a RISC chipset or a CISC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In some embodiments, processors can utilize nanoscale architectures such as, but not limited to, molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that some implementations could include, while other implementations do not include, some features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that can provide adaptive mid-packet detection (or clear channel assessment) in devices that can communicate wireless or otherwise operate according to one or more communication protocols, including current protocols and/or legacy protocols. It is, of course, not possible to describe every conceivable combination of elements and/or methods for purposes of describing the various features of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forth in the specification and annexed drawings be considered, in all respects, as illustrative and not restrictive. Although specific terms are employed herein, they are used in a generic and descriptive sense only and not for purposes of limitation.

What is claimed is:

1. An apparatus for wireless telecommunication, comprising:
at least one memory device having programmed instructions; and
at least one processor functionally coupled to the at least one memory device and configured to execute the programmed instructions, and in response to execution of the programmed instructions, the at least one processor is further configured at least to:
determine an interval prior to a transmission, wherein the interval is the difference between a first instant at which the apparatus begins to contend for a communication resource and a second instant at which a defined backoff period is expected to elapse;
select a sensing time based at least on one or more of the interval or a defined selection rule based on a signal strength threshold and a detection performance threshold; and
direct implementation of mid-packet detection using the sensing time.

2. The apparatus of claim 1, wherein the interval includes an interframe spacing period corresponding to at least one of a short interframe space (SIFS) period or an arbitration interframe space (AIFS) period, and wherein the backoff period corresponds to a defined slot time multiplied by a defined number of slots constituting the backoff period, and further wherein the sensing time is less than the interval.

3. The apparatus of claim 1, wherein the defined selection rule is further based on a second signal strength threshold, and wherein the at least one processor is further configured to perform the mid-packet detection in at least one of a primary channel or a secondary channel.

4. The apparatus of claim 1, further comprising a mid-packet detection unit that implements the mid-packet detection using the sensing time, wherein the mid-packet detection unit selects a threshold to ascertain presence of wireless signal during the implementation of the mid-packet detection, and wherein the threshold is based on the detection performance threshold.

5. The apparatus of claim 1, wherein the at least one processor is further configured to select the sensing time from a group consisting of 43 μs, 61 μs, and 70 μs.

6. The apparatus of claim 1, wherein sensing time is in a range from about 40 μs to about 100 μs.

7. The apparatus of claim 1, wherein the at least one processor is further configured to select the sensing time from a group consisting of a first interval spanned by two orthogonal frequency division multiplexing (OFDM) symbols in a radio communication protocol, a second interval spanned by three OFDM symbols in the radio communication protocol, and a third interval spanned by four OFDM symbols in the radio communication protocol.

8. The apparatus of claim 7, wherein an OFDM symbol of the two OFDM symbols, the three OFDM symbols, or the four OFDM symbols has a symbol duration of equal to about 12.4 μs and a defined guard interval.

9. The apparatus of claim 7, wherein the radio communication protocol comprises a protocol from the IEEE 802.11ax standard.

10. The apparatus of claim 1, further comprising a radio unit functionality coupled to the at least one processor, wherein the radio unit is configured to receive wireless signal according to a define radio communication protocol.

11. The apparatus of claim 10, further comprising one or more antennas functionally coupled to the radio unit.

12. At least one computer-readable non-transitory storage medium having instructions encoded thereon that, in response to execution, cause at least one processor to perform operations comprising:
determining an interval prior to a transmission, wherein the interval is the difference between a first instant at which the apparatus begins to contend for a communication resource and a second instant at which a defined backoff period is expected to elapse;
selecting a sensing time based at least on one or more of the interval or a defined selection rule based on signal strength thresholds and a detection performance threshold; and
performing mid-packet detection using the sensing time.

13. The at least one computer-readable non-transitory storage medium of claim 12, the operations further comprising:
selecting a threshold to ascertain presence of a wireless signal during the mid-packet detection.

14. The at least one computer-readable non-transitory storage medium of claim 12, wherein the selecting comprises selecting one of a group of defined sensing times.

15. The at least one computer-readable non-transitory storage medium of claim 14, wherein the group of defined sensing times includes a defined maximum sensing time.

16. A device, comprising:
circuitry configured at least to:
determine an interval prior to a transmission from a communication device containing the circuitry;
select a sensing time based at least on one or more of the interval or a defined selection rule based on signal strength thresholds and a detection performance threshold; and
implement mid-packet detection using the sensing time.

17. The device of claim 16, wherein the circuitry is further configured to perform the mid-packet detection in at least one of a primary channel or a secondary channel.

18. The device of claim 16, wherein the circuitry is further configured to select a threshold to ascertain presence of wireless signal in a communication channel in the mid-packet detection.

19. The device of claim 16, wherein the circuitry is further configured to select the sensing time from a group consisting of 43 μs, 61 μs, and 70 μs.

20. The device of claim 15, wherein the circuitry is further configured to select the sensing time from a range from about 40 μs to about 100 μs.
